(19) United States
(12) Patent Application Publication
(10) Pub. No.: US 2025/0370851 A1
(43) Pub. Date: Dec. 4, 2025

(54) USING RECOVERY ALGORITHM SIGNATURES FOR MARGINAL HARDWARE INDICTMENT

(71) Applicant: Dell Products L.P., Round Rock, TX (US)

(72) Inventor: Zachary Fay, Westford, MA (US)

(73) Assignee: Dell Products L.P., Round Rock, TX (US)

(21) Appl. No.: 18/675,504

(22) Filed: May 28, 2024

(51) Int. Cl. G06F 11/07; G06F 11/00; G06F 11/34

(52) U.S. Cl. CPC G06F 11/0793; G06F 11/008; G06F 11/3409; G06F 11/3457

(57) ABSTRACT

A computer-implemented method includes receiving, upon occurrence of a recovery event associated with one of a plurality of components in a system, a set of recovery event data. Performance metrics associated with the one of the plurality of components, are retrieved. The set of recovery event data and the set of performance metrics are provided to a time sequence machine learning model which is configured to analyze the set of recovery event data and the set of corresponding performance metrics to generate a likelihood of failure metric (LOFM) for the one of the plurality of components in the system. If the LOFM exceeds a threshold, a control signal is automatically generated, the control signal configured to initiate an automatic action within the system configured to mitigate at least one impact of a possible failure of the one of the plurality of components.

### FIELD

Embodiments of the disclosure generally relate to operations of computer systems and systems and methods for predicting failures of marginally operating components of computer systems to help reduce or eliminate system level impact of those failures.

### BACKGROUND

Failure detection, prediction, and prevention is a generic and common problem across the information technology (IT) space. It is especially challenging when a component suddenly fails, seemingly without any prior detectable indicators of that the component is starting to go bad or about to fail. Despite major efforts, both in industry and academia, it can be challenging to find solutions that are reliable in helping to detect, predict, and/or prevent component failures.

### SUMMARY

The following presents a simplified summary in order to provide a basic understanding of one or more aspects of the embodiments described herein. This summary is not an extensive overview of all of the possible embodiments and is neither intended to identify key or critical elements of the embodiments, nor to delineate the scope thereof. Rather, the primary purpose of the summary is to present some concepts of the embodiments described herein in a simplified form as a prelude to the more detailed description that is presented later.

Marginally operating equipment with associated looping recovery sequences can run unindicted and without demonstrating a noticeable failure or degradation for extended periods before failure. This situation may eventually cause customer impact without obvious explanations for why a failure seems to be unexpected. Customers and other users frequently demand answers as to how such failures can go unidentified for so long without any action being taken by the system to detect or correct the anomaly. However, because current recovery algorithms simply run until a hard failure is encountered, these algorithms provide no insights into the progression of component, system, or process degradation. Degradation can be classified by system performance metrics, total time spent in recovery, or repetitive recovery actions without resultant indictment.

Various techniques for addressing this issue have been attempted. In some methodologies, analysis involves conducting performance reviews and debugging component failures. However, this technique can require lengthy manual investigation while extending impact windows. As a result, vital equipment can be out of service for longer than desired. In addition, such performance reviews can depend on manually sifting through enormous amounts of non-specific log data. This can be both challenging and ineffective.

In certain aspects, embodiments described herein propose various solutions to address at least some of these and other issues. For example, in certain embodiments, a recovery algorithm action data logging mechanism is combined with a time-sequence machine learning system running an algorithm that can be generated to predict and indict marginally operating component failures in order to reduce or eliminate system level impact.

Time series forecasting has been used to help address many important problems in data science and statistics. As is understood, a set of data can become or be transformed into a time series when that data is sampled in accordance with a time-bound attribute (seconds, minutes, hours, days, months, years, etc.), where this sampling inherently provides a built-in order to the data. Time series data can include both regular data (data taken at regular time intervals, such as by software, a sensor, or another piece of equipment, etc.) and irregular data (data created or driven by irregular events, such as user requests, external events, unexpected device issues or failures, etc.). In addition, by summarizing irregular time series, such summarizations can create a set of regular data (e.g., summarizing average response time for write requests to a storage array over one minute intervals). Forecasting involves analyzing data, such as time-series data (data from the past), to predict future values, e.g., of that data and/or future values of things dependent on or relating to that data. In machine learning, time series machine learning models can be configured to forecast the value of a target based primarily on a known history of target values. Time series machine learning models, in some instances, implement auto-regressive modeling, which is a specialized form of regression.

In environments such as computer systems, storage arrays, backup systems, servers, etc., unexpected downtime arising from equipment failures can be very costly to customers. Some manufacturers have tried to leverage predictive maintenance techniques to try and identify possible device and equipment issues before these issues lead to disruption. In systems where there are many sensors constantly churning data about components, using a time series database to help analyze performance, can seem straightforward, because time series databases can store and analyze data over long periods of time, to help identify trends and patterns (based on sensor data) that could lead to potential equipment problems. However, application of a time series database can be more challenging with some types of computer systems, because of the volume of data and the built in recovery sequences that can mask the development of hardware issues. It can be difficult to analyze that type of data. In addition, with computer systems, being able to proactively take automated action to minimize system downtime can be more challenging than in other types of environments.

In certain embodiments herein, techniques are introduced to use a time series database to help process log data and other event data, even data that may not be immediately recognized as important, to help refine the large quantities of system and component data into a more refined and usable data set, in combination with a time series machine learning model to further analyze this data and make useful predictions about equipment that may be nearing failure or which may require other types of maintenance. In certain embodiments, a time sequence machine learning model is used to help improve this process and to help implement automated actions to help minimize system town time. In certain embodiments, the time sequence machine learning model is further configured to take into account data beyond simply time sequence data, such as performance-related metrics (e.g., age or installation date of a part, part run-time, etc.). With predictions supported by a more refined data set generated from use of the improved time-series machine-learning model, as well as other aspects of the systems and methods discussed herein, a direct reduction in cost of service is expected due to a reduction of investigation and diagnosis hours.

In certain embodiments, solutions are provided for these and other issues.

In one aspect, a computer-implemented method is provided. Upon occurrence of a first recovery event associated with a corresponding one of a plurality of components in a first system, a first set of corresponding recovery event data is received. A set of first corresponding performance metrics is retrieved, the set of first corresponding performance metrics being associated with the corresponding one of the plurality of components. The first set of corresponding recovery event data and the first set of corresponding performance metrics is provided to a first time sequence machine learning model, the first time sequence machine learning model configured to analyze the first set of corresponding recovery event data and the first set of corresponding performance metrics to generate a first likelihood of failure metric for the corresponding one of the plurality of components in the first system. If the first likelihood of failure metric exceeds a first threshold, there is initiation of automatic generation of a first control signal configured to initiate an automatic action within the first system configured to mitigate at least one impact of a possible failure of the corresponding one of the plurality of components.

In certain embodiments, the automatic action is configured to trigger at least one of logical and physical isolation of the corresponding one of the plurality of components. In certain embodiments, the first time sequence machine learning model is trained using failure data associated with one or more other components having one or more characteristics in common with the corresponding one of the plurality of components of the first system. In certain embodiments, the first time sequence machine learning model is tuned based on at least one of the first set of corresponding recovery event data and the first likelihood of failure metric.

In certain embodiments, the computer-implemented method further comprises continually tuning the first time sequence machine learning model based on at least one of the first set of recovery event data and the first likelihood of failure metric and a second recovery event information and one or more second likelihood of failure metrics, wherein the second recovery event information and the one or more second likelihood of failure metrics are generated in and communicated by a second system that is in operable communication with the first system.

In certain embodiments, the computer-implemented method further comprises at least one of setting a value and adjusting a value of the first threshold based on at least one of pre-failure event data and failure event data of the first system. In certain embodiments, the computer-implemented method further comprises at least one of setting a value and adjusting a value of the first threshold based on at least one of pre-failure event data and failure event data of a second system in operable communication with the first system. In certain embodiments, the first set of corresponding recovery event data results from execution of a recovery flow having a plurality of steps and wherein the first set of corresponding recovery data comprises information relating to depth of recovery completed, the depth of recovery corresponding to progress through the plurality of steps.

In certain embodiments, the computer-implemented method further comprises storing the first likelihood of failure metric in a database, along with one or more corresponding conditions, or events associated with the first likelihood of failure metric; providing a simulation system configured to simulate the first system; configuring the simulation system to simulate the one or more corresponding conditions or events associated with the first likelihood of failure metric; exercising a predetermined recovery flow in the simulation system, wherein the predetermined recovery flow is configured to perform at least one action responsive to mitigate an issue simulated in the simulation system; evaluating the predetermined recovery flow based on how well it mitigates the issue; and adjusting the predetermined recovery flow, based on results of exercising it in the simulation system, to improve an ability of the predetermined recovery flow to mitigate the issue.

In certain embodiments, the computer-implemented method further comprises aggregating at least one of recovery event data and performance metrics from the plurality of components into a set of aggregated field data; and tuning the first time sequence machine learning model based at least in part on the aggregated field data.

In another aspect, a system is provided, comprising a processor and a non-volatile memory in operable communication with the processor and storing computer program code that when executed on the processor causes the processor to execute a process operable to perform certain operations. One operation includes receiving, upon occurrence of a first recovery event associated with a corresponding one of a plurality of components in a first system, a first set of corresponding recovery event data. One operation includes retrieving a set of first corresponding performance metrics associated with the corresponding one of the plurality of components. One operation includes providing the first set of corresponding recovery event data and the first set of corresponding performance metrics to a first time sequence machine learning model, the first time sequence machine learning model configured to analyze the first set of corresponding recovery event data and the first set of corresponding performance metrics to generate a first likelihood of failure metric for the corresponding one of the plurality of components in the first system. One operation includes initiating, if the first likelihood of failure metric exceeds a first threshold, automatic generation of a first control signal configured to initiate an automatic action within the first system configured to mitigate at least one impact of a possible failure of the corresponding one of the plurality of components.

In certain embodiments, the automatic action is configured to trigger at least one of logical and physical isolation of the corresponding one of the plurality of components. In certain embodiments, the processor executes a process operable to provide computer program code that when executed on the processor causes the processor to perform an action comprising at least one of setting a value and adjusting a value of the first threshold based on at least one of pre-failure event data and failure event data of the first system. In certain embodiments, the processor executes a process operable to provide computer program code that causes the processor to perform an action comprising at least one of setting a value and adjusting a value of the first threshold based on at least one of pre-failure event data and failure event data of a second system in operable communication with the first system.

In certain embodiments, the processor executes a process operable to provide computer program code that when executed on the processor causes the processor to perform actions of: aggregating at least one of recovery event data and performance metrics from the plurality of components into a set of aggregated field data; and tuning the first time sequence machine learning model based at least in part on the aggregated field data. In certain embodiments, the first set of corresponding recovery event data results from execution of a recovery flow having a plurality of steps and wherein the first set of corresponding recovery data comprises information relating to depth of recovery completed, the depth of recovery corresponding to progress through the plurality of steps.

In another aspect, a computer program product is provided that includes a non-transitory computer readable storage medium having computer program code encoded thereon that when executed on a processor of a computer causes the computer to operate a failure prediction system. The computer program product comprises computer program code for receiving, upon occurrence of a first recovery event associated with a corresponding one of a plurality of components in a first system, a first set of corresponding recovery event data. The computer program product also comprises computer program code for retrieving a set of first corresponding performance metrics associated with the corresponding one of the plurality of components. The computer program product also comprises computer program code for providing the first set of corresponding recovery event data and the first set of corresponding performance metrics to a first time sequence machine learning model, the first time sequence machine learning model configured to analyze the first set of corresponding recovery event data and the first set of corresponding performance metrics to generate a first likelihood of failure metric for the corresponding one of the plurality of components in the first system. The computer program product also comprises computer program code for initiating, if the first likelihood of failure metric exceeds a first threshold, automatic generation of a first control signal configured to initiate an automatic action within the first system configured to mitigate at least one impact of a possible failure of the corresponding one of the plurality of components.

In certain embodiments, the computer program product further comprises computer program code for triggering at least one of logical and physical isolation of the corresponding one of the plurality of components. In certain embodiments, the first set of corresponding recovery event data results from execution of a recovery flow having a plurality of steps and wherein the first set of corresponding recovery data comprises information relating to depth of recovery completed, the depth of recovery corresponding to progress through the plurality of steps. In certain embodiments, the computer program product further comprises computer program code for aggregating at least one of recovery event data and performance metrics from the plurality of components into a set of aggregated field data; and computer program code for tuning the first time sequence machine learning model based at least in part on the aggregated field data.

Implementations of the described techniques may include hardware, a method or process, or computer software on a computer-accessible medium.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the claims included herein.

Details relating to these and other embodiments are described more fully herein.

### BRIEF DESCRIPTION OF THE DRAWINGS

The advantages and aspects of the described embodiments, as well as the embodiments themselves, will be more fully understood in conjunction with the following detailed description and accompanying drawings, in which:

FIG. 1 is an exemplary architecture of a first storage array system, including modifications to include a predictive system and other modules, in accordance with one embodiment;

FIG. 2 is an exemplary block diagram of a second storage array system, the second storage array system providing more details regarding the first storage array system of FIG. 1, in accordance with one embodiment;

FIG. 3 is a more detailed block diagram of the processing module of FIGS. 1 and 2, in accordance with one embodiment;

FIG. 4 is more detailed block diagram of the predictive system of FIGS. 1 and 2, in accordance with one embodiment;

FIG. 5 is a more detailed block diagram of the storage arrays subsystem of FIGS. 1 and 2, in accordance with one embodiment;

FIG. 6A is a first exemplary flowchart of a method of using recovery information to generate likelihood of failure metrics configured to identify and predict failing and/or marginal hardware, usable in the storage array systems of FIGS. 1 and 2, in accordance with one embodiment;

FIG. 6B is a second exemplary flowchart of a method of using the likelihood of failure metrics generated in FIG. 6A to help exercise recovery sequences, in accordance with one embodiment;

FIG. 7 is a first table showing an illustrative example of a set of recovery data for several components of the storage arrays subsystem of FIGS. 1 and 2, in accordance with one embodiment;

FIG. 8 is a second table showing an illustrative example of performance metrics for several components of the storage array system of FIGS. 1 and. 2, in accordance with one embodiment;

FIG. 9 is a third table showing illustrative error information for a first exemplary component of the storage array system of FIGS. 1 and 2, in accordance with one embodiment;

FIG. 10A is fourth table showing an illustrative flow of recovery actions for one type of error associated with the first exemplary component of FIG. 9, in accordance with one embodiment;

FIG. 10B is a fifth table showing an illustrative set of recovery information for the first exemplary component of FIG. 9, using the recovery sequence of FIG. 10A, in accordance with one embodiment; and

FIG. 11 is a block diagram of an exemplary computer system usable with at least some of the systems, methods, examples, and outputs of FIGS. 1-10B, in accordance with one embodiment.

The drawings are not to scale, emphasis instead being on illustrating the principles and features of the disclosed embodiments. In addition, in the drawings, like reference numbers indicate like elements.

### DETAILED DESCRIPTION

Before describing details of the particular systems, devices, arrangements, frameworks, and/or methods, it should be observed that the concepts disclosed herein include but are not limited to a novel structural combination of components and circuits, and not necessarily to the particular detailed configurations thereof. Accordingly, the structure, methods, functions, control and arrangement of components and circuits have, for the most part, been illustrated in the drawings by readily understandable and simplified block representations and schematic diagrams, in order not to obscure the disclosure with structural details which will be readily apparent to those skilled in the art having the benefit of the description herein.

Illustrative embodiments will be described herein with reference to exemplary computer and information processing systems, in particular the environment of a storage array system. It is to be appreciated, however, that embodiments are not restricted to use with the particular illustrative system and device configurations shown and are not restricted to storage array environments.

Unless specifically stated otherwise, those of skill in the art will appreciate that, throughout the present detailed description, discussions utilizing terms such as “opening”, “configuring,” “receiving,”, “detecting,” “retrieving,” “converting”, “providing,”, “storing,” “checking”, “uploading”, “sending,”, “determining”, “reading”, “loading”, “overriding”, “writing”, “creating”, “including”, “generating”, “associating”, and “arranging”, and the like, refer to the actions and processes of a computer system or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The disclosed embodiments are also well suited to the use of other computer systems such as, for example, optical and mechanical computers. Additionally, it should be understood that in the embodiments disclosed herein, one or more of the steps can be performed manually.

In addition, as used herein, terms such as “module,” “system,” “subsystem”, “engine,” “gateway,” “device,”, “machine”, “interface, and the like are intended to refer to a computer-implemented or computer-related in this application, the terms “component,” “module,” “system”, “interface”, “engine”, or the like are generally intended to refer to a computer-related entity or article of manufacture, either hardware, software, a combination of hardware and software, software, or software in execution. For example, a module includes but is not limited to, a processor, a process or program running on a processor, an object, an executable, a thread of execution, a computer program, and/or a computer. That is, a module can correspond to both a processor itself as well as a program or application running on a processor. As will be understood in the art, modules and the like can be distributed on one or more computers.

Further, references made herein to “certain embodiments,” “one embodiment,” “an exemplary embodiment,” and the like, are intended to convey that the embodiment described might be described as having certain features or structures, but not every embodiment will necessarily include those certain features or structures, etc. Moreover, these phrases are not necessarily referring to the same embodiment. Those of skill in the art will recognize that if a particular feature is described in connection with a first embodiment, it is within the knowledge of those of skill in the art to include the particular feature in a second embodiment, even if that inclusion is not specifically described herein.

Additionally, the words “example” and/or “exemplary” are used herein to mean serving as an example, instance, or illustration. No embodiment described herein as “exemplary” should be construed or interpreted to be preferential over other embodiments. Rather, using the term “exemplary” is an attempt to present concepts in a concrete fashion. In addition, the articles “a” and “an” as used in this application and the appended claims should be construed to mean “one or more” unless specified otherwise or clear from context to be directed to a singular form.

Before describing in detail, the particular improved systems, devices, and methods, it should be observed that the concepts disclosed herein include but are not limited to a novel structural combination of software, components, and/or circuits, and not necessarily to the particular detailed configurations thereof. Accordingly, the structure, methods, functions, control and arrangement of components and circuits have, for the most part, been illustrated in the drawings by readily understandable and simplified block representations and schematic diagrams, in order not to obscure the disclosure with structural details which will be readily apparent to those skilled in the art having the benefit of the description herein.

The following detailed description is provided, in at least some examples, using the specific context of a networked storage array system and modifications and/or additions that can be made to such a system to achieve the novel and non-obvious improvements described herein. Those of skill in the art will appreciate that the embodiments herein may have advantages in many contexts other than a storage array system. Thus, in the embodiment herein, specific reference to specific activities and environments is meant to be primarily for example or illustration. Moreover, those of skill in the art will appreciate that the disclosures herein are not, of course, limited to only the types of examples given herein, but are readily adaptable to many different types of arrangements that involve monitoring, predicting, and mitigating for the failure of components, systems, devices, etc., where data is collected that associated with the operation and/or performance of the component, system, and/or device.

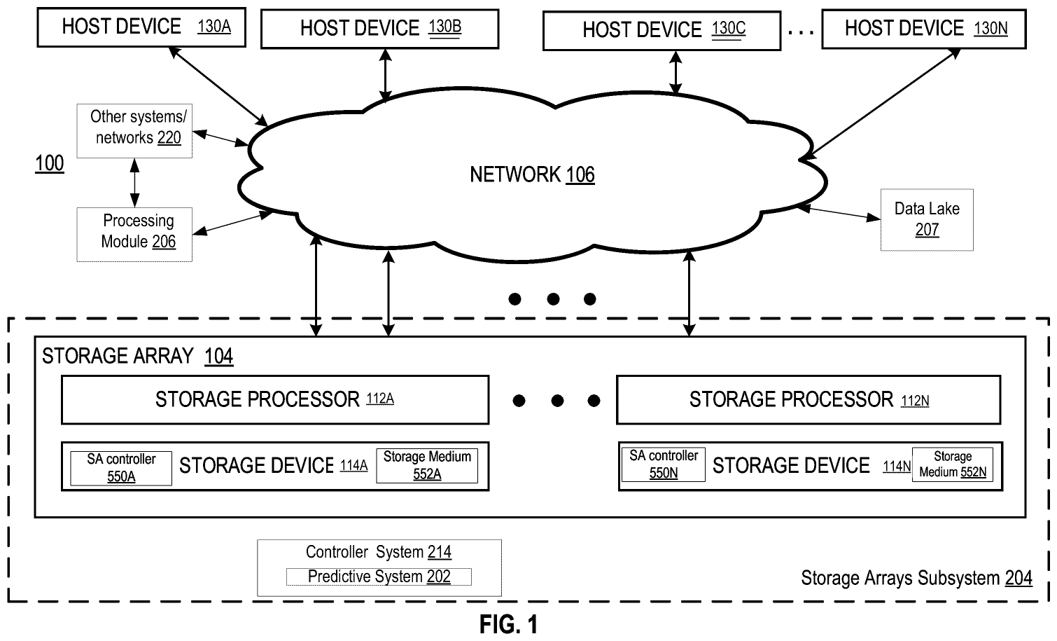

A storage system may include a plurality of storage devices (e.g., storage arrays) to provide data storage to a plurality of nodes, such as host devices. The plurality of storage devices and the plurality of nodes may be situated in the same physical location, or in one or more physically remote locations. The plurality of nodes may be coupled to the storage devices by a high-speed interconnect, such as a fabric network or other type of computer network. For example, FIG. 1 is an exemplary architecture of a first storage array system 100, in accordance with one embodiment. The first storage array system 100 includes modifications to include a predictive system and other modules, as discussed further herein. As illustrated, the first storage array system 100 may include a storage arrays subsystem 204, a communications network 106, and a plurality of host devices 130 (e.g., host devices 130A-130N. The communications network 106 may include one or more of a fibre channel (FC) network, the Internet, a local area network (LAN), a wide area network (WAN), and/or any other suitable type of network. In some embodiments, the communications network 106 is a cloud network. The storage arrays subsystem may include a storage array 104 and a controller system 214. In some embodiments, the first storage array system 100 may have an optional processing module 206 and/or other systems/networks 220 also in operable communication with the communications network 106.

The storage array 104 may include a storage system, such as DELL/EMC Powermax™ (available from Dell Corporation of Round Rock, TX), DELL PowerStore™, and/or any other suitable type of storage system. The storage array 104 may include or be arranged with one or more node-pairs and a plurality of storage devices 114A-114N, which advantageously can be non-volatile memory types of devices. The storage devices 114A-114N may be configured in a RAID-1 configuration with corresponding mirrored memories, but this is not limiting. Each node of the node pairs may include one or more storage processors 102A-103N. Each of the storage processors 102A-102N may be configured to receive Input/Output (I/O) requests from host devices 130A-130N and execute the received I/O requests by reading and/or writing data to storage devices 114A-114N. Each of the host devices 130A-130N may include a desktop computer, a laptop, a smartphone, an internet-of-things (IoT) device, a computing device embedded in or part of another system (e.g., a computer coupled to or as part of a means of transport, such as a vehicle, aircraft, vessel, etc.) and/or any other suitable type of computing device, as will be understood.

According to one aspect, each of the storage devices 114A-114N may be a non-volatile memory express (NVMe) drive. In another aspect, the storage devices may be solid-state drives (SSD). In some implementations, each of the storage devices 114 may be connected to the storage processors 102A-102N via a Peripheral Component Interconnect Express (PCIe) connection. Each of the storage devices 114A-114N may include a respective controller 550A-550N and storage medium 552A-552N. Each controller 550A-550N of each storage device 114A-114N may include processing circuitry that is configured to perform various tasks, such as the retrieval and storage of data on the medium, wear leveling, error handling, garbage collection, as well as other functions. Each storage device of the 114A-114N may include an array of NAND memory cells and/or any other suitable type of storage medium.

In some implementations, any of the storage devices 114A-115N may be internal to one of the storage processors 102A-102N and coupled to a given storage processor 102A-102N via an M.2 slot that is provided on the motherboard of that storage processor 102A-102N. Additionally, or alternatively, in some implementations, any of the storage devices 114A-114N may be part of a disk array enclosure (DAE) (not shown) and coupled to each of the storage processors 102A-102N via a respective InfiniBand adapter of the respective storage processor 102A-102N. It will be understood that the present disclosure is not limited to any specific method for connecting storage devices 114A-114N to storage processors 102A-102N.

The controller system 214 is configured to communicate with the storage processors 112A-112N to help control operation of the storage array 104 as well as to help receive data from the storage array 104 (via a storage bus, discussed further herein) to provide information to a local time series database (which is part of the predictive system 202 and discussed further herein) and, optionally to other systems/networks 220 and/or processing module 206 that help to analyze data, as discussed further herein. In certain embodiments, a data storage entity, such as a data lake 207, is in operable communication with the network 106. As is understood, a data lake is a centralized repository that provides for storage, processing, and securing of of structured, semi-structured and unstructured data, at any scale, wherein advantageously the data is stored in its native format and wherein the data lake is configured to be able to process any variety of data without consideration of size limits.

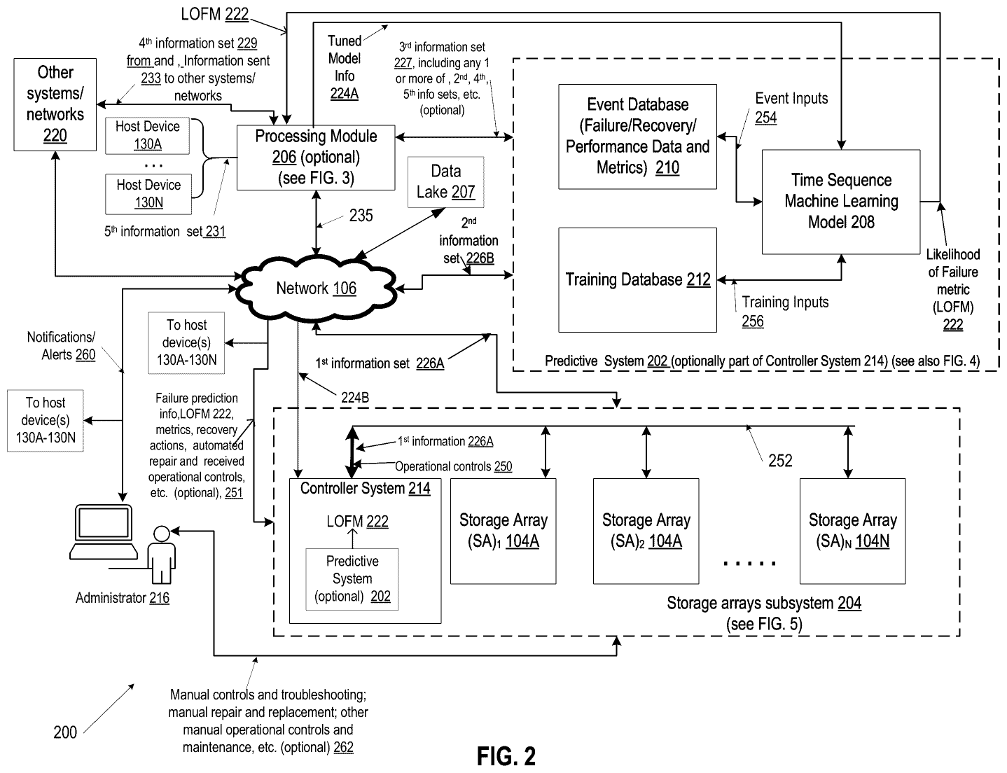

FIG. 2 is an exemplary block diagram of a second storage array system 200, the second storage array system 200 providing more details regarding the first storage array system 100 of FIG. 1, in accordance with one embodiment, including showing an embodiment where the storage arrays subsystem 204 includes a plurality of storage arrays 104A-104N configured together with the controller system 214 as part of the storage arrays subsystem 204; however, in some embodiments, there may be only a single storage array 104 with its own built in controller system 214 (and predictive system 202) as will be appreciated. In certain embodiments, as well, the predictive system 202 can be part of the second storage array system 200 but be disposed separately from the controller system 214 and/or separately from the storage arrays subsystem 204.

For clarity in conveying the arrangement, FIG. 2 depicts the predictive system 202 in its own separate block, but, as shown in FIG. 2, in at least some embodiments, the predictive system 202 of FIG. 2 actually is part of the controller system 214 and is configured to provide tracking of recovery and failure events of the storage arrays subsystem 204, along with other information and metrics, in one or more time series databases (e.g., event database 210 and training database 212) that operate in cooperation with a time sequence machine learning model 208, as discussed further herein.

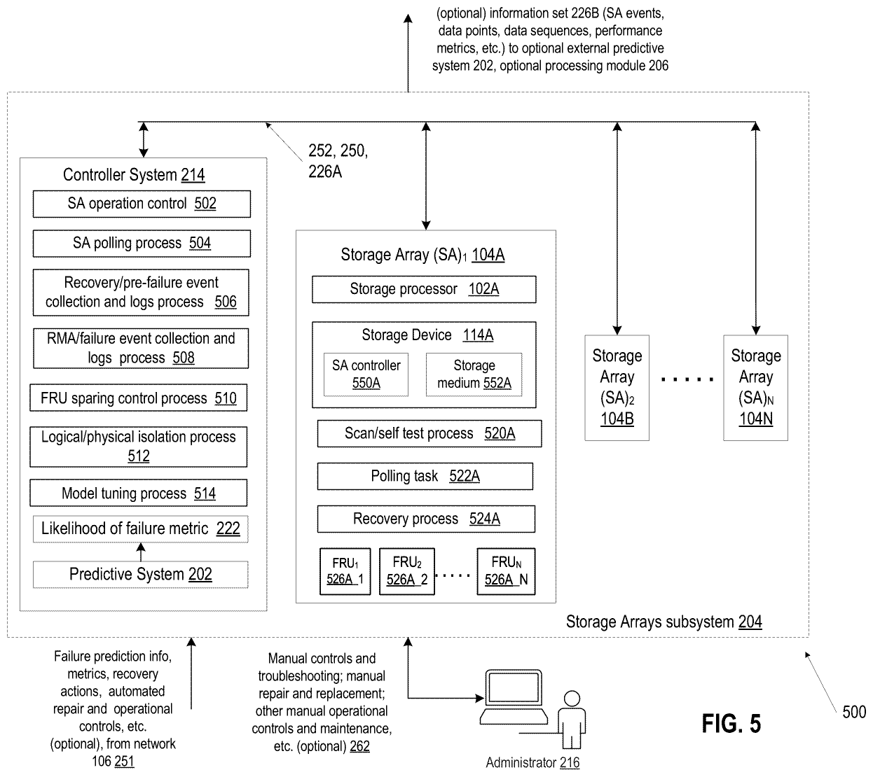

The storage arrays subsystem 204 communicates or provides a first information set 226A, including information such as storage array (SA) events, data points, data sequences, and/or performance metrics (or any other pertinent information) via a storage bus 252 to entities within the storage arrays subsystem 204 that use and/or store that first information set 226A, such as the controller system 215 and the predictive system 202. Optionally, the storage bus 253 is in operable communication with communications network 106 to enable information to be sent to the optional processing module 206, to an (optional) external predictive system 202, and, optionally, to other systems/networks 220, such as other systems and networks that may gather data from multiple systems as part of machine learning. Advantageously, in certain embodiments, the first information set 226A includes all recovery events executed against devices within the storage arrays subsystem 204 which can be tracked in logs or other data collection systems, such as recovery events associated with field replaceable units (FRU's) 526 (see FIG. 5) in the storage arrays 104A-104N. This is discussed further herein.

In some embodiments, the host devices 130A-130N, in certain embodiments, optionally communicate a respective data set (here termed a fifth information set 231) that includes, for those host devices 130A-130N, corresponding host device events, data points, data sequences and/or performance metrics, etc., via the communications network 106, to the predictive system 202, to be stored in the event database 210 and/or used in the training database 212. In certain embodiments, the host devices 130A-130N can be configured to run their own instance of a predictive system 202, as will be understood. In addition, host devices 130A-130N can communicate certain types of information and events to the storage arrays 104A-104N, such as information regarding whether a link is down. However, as will be understood, if the host devices 130A-130N are not under control of the storage arrays subsystem 204, the controller system 214 would not be configured to generate signals (e.g., to automatically generate control signals) to take any corrective actions. Optionally, if the second system 200 of FIG. 2 is configured with the optional processing module 206, it is possible that the processing module may initiate automatic generation of one or more controls (i.e., help to automatically generate or provide controls) to help the host devices 130A-130N take corrective action. In certain embodiments, the fifth information set 231 and first information set 226A are combined and provided as second information set 226B to an (optional) external predictive system 202, but this is not limiting. Each of the first information set 226A and second information set 226B can be provided distinctly, as will be appreciated, and in certain embodiments, any one or more of the information sets shown in FIG. 2 can be provided to the optional processing module 206, which can than aggregate them to provide them as part of a third information set 227, or provide them as individual information sets, as will be appreciated. The optional processing module 206, in certain embodiments, is configured to provide centralized processing of aggregated data (e.g., aggregated field data) from multiple systems/networks 220 (including the storage arrays subsystem 204) to be able to push out continually tuned model information 224 to be used in connection with the time sequence machine learning model 208 and other time series machine learning models on other systems. For example, in certain embodiments, a centralized compute platform, such as the processing module 206, can be configured to do model tuning and other types of tuning, such as superset tuning.

In certain embodiments, other systems/networks 220 can communicate a fourth information set 229 that can be used by the either or both of the predictive system 202 within the controller system 214 and/or an (optional) external predictive system 202. In certain embodiments, the fourth information set 229 includes information received from the other systems/networks 220, such as tuned model information from other machine learning models (discussed further herein), events, data points, data sequences and/or performance metrics from other systems, etc. The second storage array system 200 also can provide sent information 233 to the other systems/networks 220, which sent information 233 can include tuned model information 224 associated with the time sequence machine learning model 208, any information from the first information set 226A, second information set 226B, third information set 227, fifth information set 231, etc.

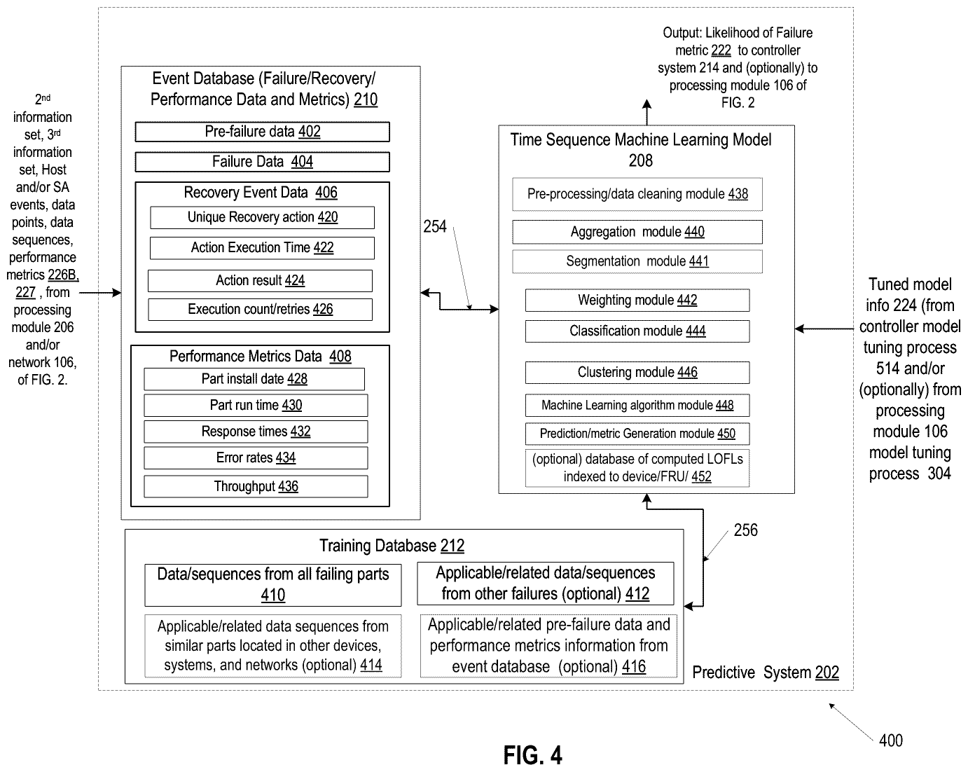

The predictive system 202 (which is detailed further in FIG. 4, discussed further herein), includes a time sequence machine learning model 208 (in at least some embodiments the time sequence machine learning model 208 also is a time series machine learning model), and two time series databases: an event database 210 and a training database 212. In some embodiments, the event database 210 and the training database 212 may be part of the same database or may be combined. Information such as the aforementioned information sets (e.g., second information set 226B, including SA events, data points, data sequences, and performance metrics, and third information set 227) are received at the predictive system 202 (e.g., via the communications network 106 (if an (optional) external predictive system 202) and/or the storage bus 252 (if internal to the controller system 213), and the received information is locally tracked in one or both of the event database 210 and/or the training database 212.

In certain embodiments, the first information set 226 comprises subset of recovery events executed against predetermined devices (e.g., so-called field-replaceable units (FRUs) 526 (see FIG. 5) within the one or more storage arrays 104A-104N. In some embodiments the first information set 226 comprises all recovery events executed against predetermined devices. In certain embodiments, recovery event data points include data such as the unique recovery action, action execution time, action result, and execution count (i.e. retries), as detailed further herein in FIG. 4. In certain embodiments, the event database 210 is configured also to store performance data and metrics, such as part install date, part run time, response times, error rates, and throughput, as detailed further herein in FIG. 4. Similarly, the fifth information set 231, in certain embodiments, includes host device events, data points, data sequences and/or performance metrics, etc., associated with the host devices 130A-130N, and this data also can be stored in one or both of the event database 210 and/or the training database 212.

Advantageously, in certain embodiments, the actions tracked in the event database 210 and/or training database 212 are configured to be limited to actions performed during normal operation of the second storage array system 200 (e.g., normal operation of the storage arrays subsystem 204 and/or host devices 130A-130N), to help avoid skewing the time sequence machine learning model 208 with larger scale instances and events that are not always related to recovery types of issues but which may produce a lot of data points, such as such as system initialization or power loss events. In certain embodiments, the time sequence machine learning model 208 is trained on data sequences and/or other data from all failing parts, wherever they are located within the second storage array system 200. In certain embodiments, the time sequence machine learning model 208 is trained using failure data associated with components having one or more characteristics in common with components of the second storage array system, e.g., similar types of components that might be found even in other networks/systems 220. In certain embodiments, the failing parts used for training may include failing parts from other systems/networks 220 (which information can be contained in the fourth information set 229). Thus, optionally, in some embodiments, a third information set 227 of data from other systems/networks 220 (which can be derived from the fourth information set 229), also is provided to the predictive system 202. In some embodiments, if the predictive system 202 is not part of the storage arrays subsystem 204, data can be provided via optional processing module 206 and/or via communications network 106. This third information set 227 can help to supplement information in the training database 212 used for providing training data inputs 256 to the time sequence machine learning model 208.

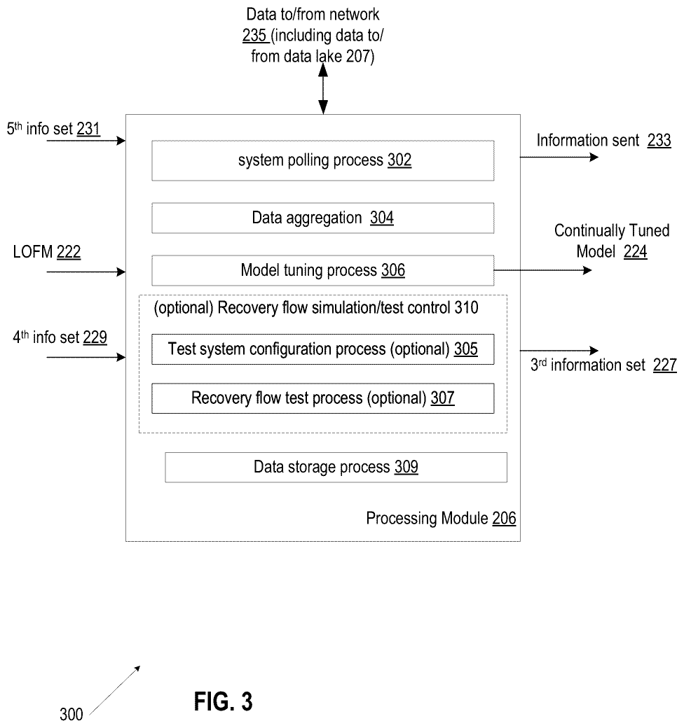

The time sequence machine learning model 208 receives and/or polls for event inputs 254 from event database 210, training data inputs 256 from training database 212, and tuned model information 224 (e.g., from the controller system 214 but tuned model information 224 also can be generated automatically by the optional processing module 206, as discussed further herein). Based at least in part on this information and on using a machine learning algorithm (see FIG. 4), the time sequence machine learning model 208 automatically generates a likelihood of failure metric 222 and provides the likelihood of failure metric (LOFM) 222 back to the controller system 214 (and/or back to the optional processing module 206), as discussed further below and in FIGS. 3 and 4).

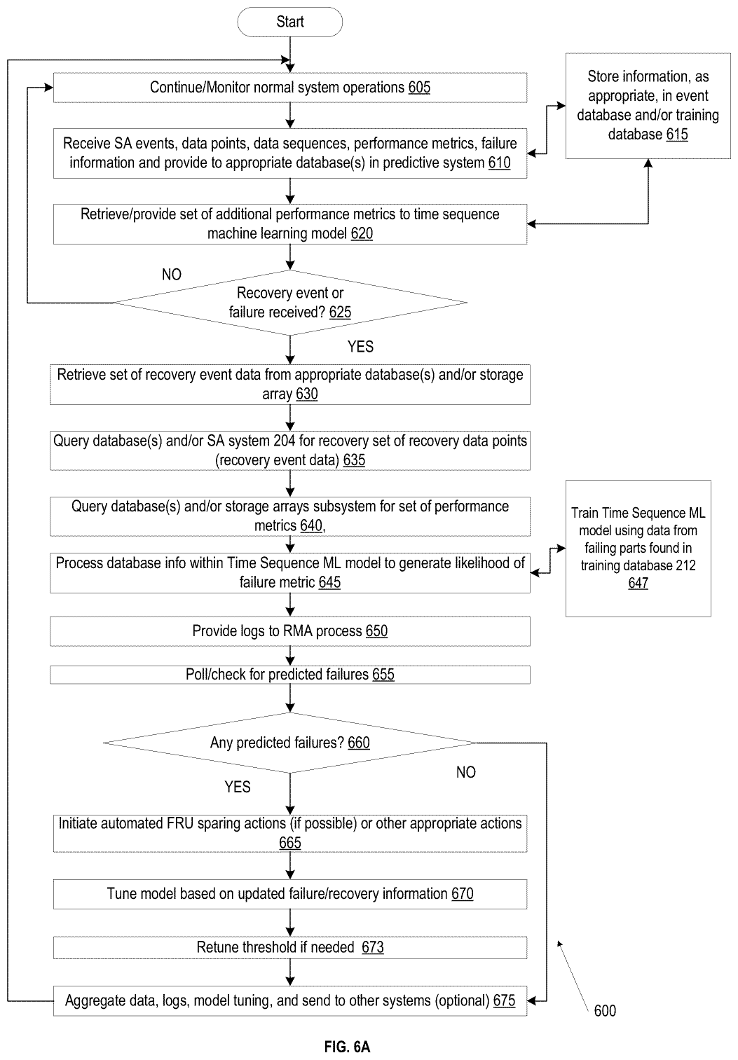

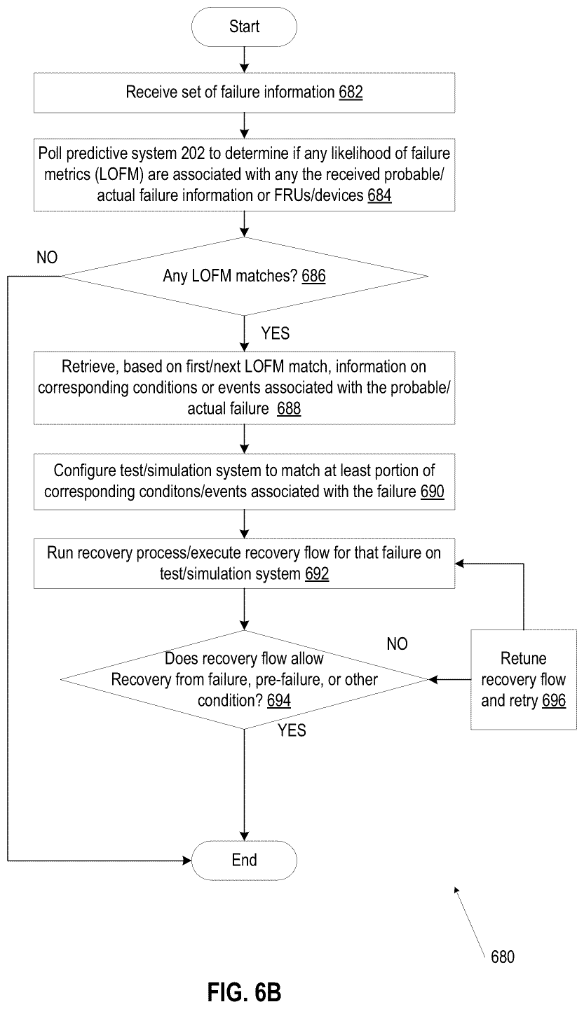

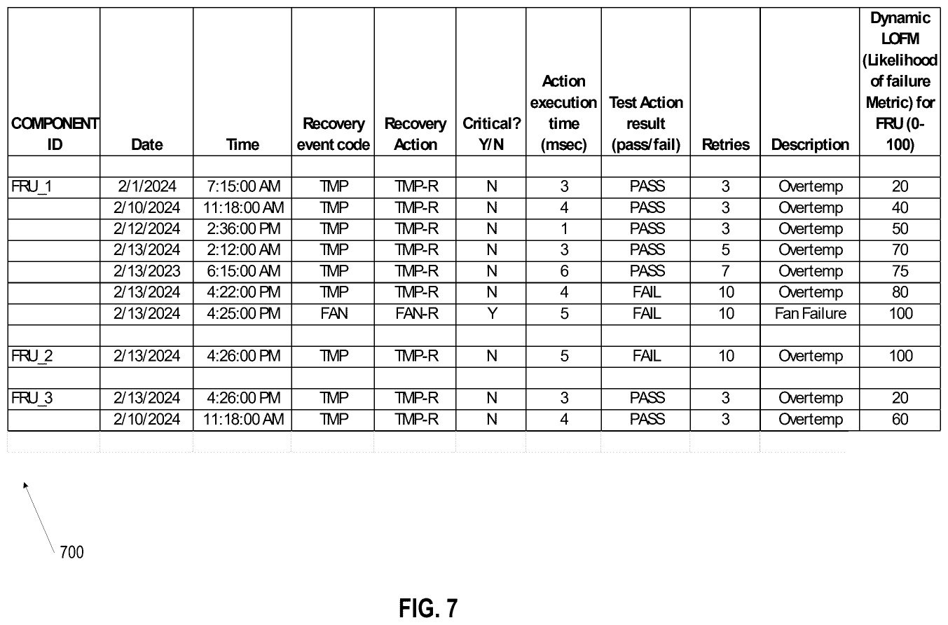

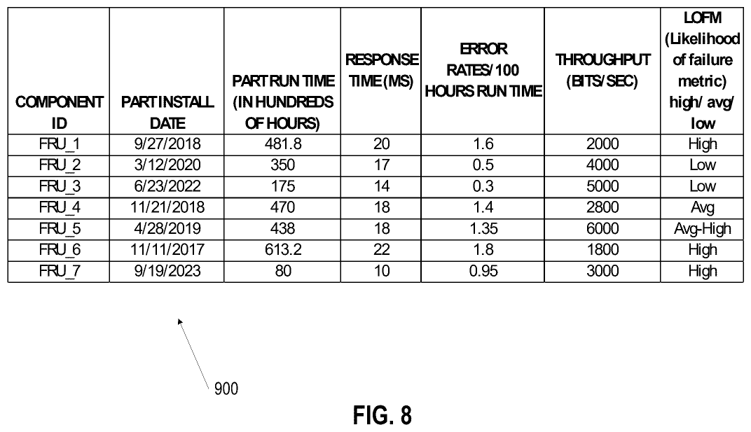

As discussed further herein in connection with FIGS. 7 and 8, the LOFM 222 may be represented in multiple different ways that can convey a likelihood of failure. A task running on either or both of the optional processing module 206 and/or controller system 214 can be configured to poll the predictive system 202 for predicted failures (discussed further herein in connection with the method of FIG. 6) or to poll for other desired information. This task can be configured to determine the LOFM 222 in many different ways and at different times, such as periodically, on demand, in response to predetermined events (such as a failure of another component), as well as dynamically or continuously, in real time. Based on the value or indication of the LOFM 222, the controller system 214 (and/or the optional processing module 206) is configured to take one or more actions, which actions can vary and can, in certain embodiments, include either or both of automated and/or manual actions, including FRU sparing actions.

For example, in certain embodiments, the controller system 214 can automatically generate one or more automated operational controls 250 (or, optionally, receive such controls from the optional processing module 206), and/or other types of recovery actions (e.g., notifications, running automated troubleshooting, performing logical/physical isolation etc.) based on the LOFM 222, to enable it to take action based on a predicted failure. For example, in some embodiments, the automated operational controls 250 can cause the storage arrays subsystem 204 to trigger automatic logical or physical isolation of one or more components or FRU 526 associated with the LOFM 222. This is discussed further herein. In certain embodiments, example, the controller system 214 can provide notifications/alerts 260 to an administrator 216 or other user (e.g., an operator or user of a host device 130) who can take manual actions 262 (e.g., troubleshooting, manual repair and replacement, maintenance, etc.) to help prevent or resolve the predicted failure. This is also discussed further herein.

Based on the likelihood of failure metric 222 (i.e., effectively, on analysis and machine learning of the recovery information and other appropriate information contained in the first information set 226A, on the fifth information set 231, on the fourth information set 229, and/or other information from other system/networks 220), the controller 214 is configured also to adjust the time sequence machine learning model 208 by providing tuned model information 224 to the time sequence machine learning model 208. In some embodiments, the optional processing module 206 also can be configured to adjust the time sequence machine learning model 208 instead of, or in addition, to the controller system 214 and can be configured to provide tuned model information 224 as well. This tuned model information 224 helps to improve the prediction performance of the time sequence machine learning model 208. Optionally, the tuned model information 224 may be provided to other systems/networks 220 via sent information 233, where this may include information that includes tuned model information, data and information from the third information set 227, failure information, etc.

Reference is now made to FIG. 3, which is a more detailed block diagram 300 of the optional processing module 206 of FIG. 2, in accordance with one embodiment. The optional processing module 206, like the controller system 214 (which is discussed further in connection with FIG. 5) includes multiple processing modules that help to implement the functions described previously in connection with FIG. 2 as well as discussed further herein in connection with the methods of FIGS. 6A and or 6B (discussed further herein). In certain embodiments, the optional processing module 206 is configured as a “remote” module that makes baseline adjustments (e.g., to the time sequence machine learning model 208) based on all storage arrays in aggregate, e.g., storage arrays 104A-104N of FIG. 2 as well as other storage arrays (not visible in FIG. 2) which are accessible via other systems/networks 220. The local instance of the model tuning process 514 (see FIG. 5) that is running in controller system 214 (as discussed further herein) is configured to make “fine tune” type of adjustments to the time sequence machine learning model 208, based only on the local storage array. The optional processing module 206, in certain embodiments, includes a system polling process 302, a data aggregation process 304, and a model tuning process 306. In certain embodiments, to help implement the optional method of FIG. 6B, the processing module may include an optional recovery exercise system 310, including an optional test system configuration process 305 and an optional recovery flow test process 307, which are discussed further herein in connection with FIG. 6B.

The system polling process 302 helps to run one or more tasks to help poll the predictive system 202 (and, optionally, other systems/networks 220) for LOFM 222 and for recovery data and other data that can be aggregated via the data aggregation process 304 and provided to the model tuning process 306, to help automatically generate continually tuned models (e.g., continually tuned time sequence machine learning models 208) that can be pushed out to the storage arrays subsystem 204 and to other systems/networks 220. The system polling process 302 also receives data from the network 235 (e.g., data that has been stored in/written to data lake 207).

Referring still to FIG. 3, the data aggregation process 304 is configured to parse the first information set 226A (FIG. 2) to help group together data for storage in the event database 210 and/or the training database 212. For example, in some embodiments, the data aggregation process 304 parses the first information set 226A for all recovery events executed against components (e.g., field replaceable units (FRUs)) within the storage arrays subsystem 204. Such recovery events could be found both in failure data and in pre-failure (i.e., “normal”) data, as will be understood. A data storage process 309 is configured to store data in and retrieve data from data lake 207.

FIG. 4 is more detailed block diagram 400 of the predictive system of FIG. 2, in accordance with one embodiment, including further details on the modules of the event database 210, the training database 212 and the time sequence machine learning model 208, in accordance with one embodiment. The inputs to the predictive system 202 include the second information set 226B and third information set 227, respectively, and tuned model information 224, as discussed above. The output of the predictive system is the likelihood of failure metric 222. In some embodiments, the event database 210 serves as the training database 212, and in some embodiments, the event database 210 and the training database 212 are separate entities. Advantageously, in certain embodiments, the event database 210 and/or training database 212 include data in an “expected” format, with which the time sequence machine learning model 208 is able to process. In certain embodiments, at least some data in either or both of the event database 210 and/or training database 212 can include data in an unexpected or unfamiliar format, and optional ingestion logic (not shown) can be provided to convert and/or adapt the data to fit into expected formats, as will be understood.

In certain embodiments, the training database 212 is configured to store various types of training data 256 that is provided to the time sequence machine learning model 208 to help train it to recognize and predict failures and failure patterns, especially with marginally operating devices and equipment that may be associated with looping recovery sequences that may run for extended periods without indicating or indicting a component or device as an actual failed component, until it may be too late to prevent undesirable impacts from the failure. Thus, the training database 212, in certain embodiments, can include both failure and pre-failure data from parts that ultimately failed. In the embodiment of FIG. 4, the training database 212 includes a first data subset 410 that includes data and data sequences from all failing parts of the second storage array system 200 (FIG. 2) and, optionally, the training database includes as well as one or more optional additional subsets, such as:
a second data subset 412 storing applicable and/or related data and/or sequences from other failures that are associated with other types of devices;
a third data subset 414 that includes applicable and/or related data and and/or data sequences from similar parts (to those failing in the first data subset 410) but which are located in other devices, systems, and networks; and
a fourth data subset 416 that include applicable and/or related pre-failure data and performance metrics information from the event database 410.

The event database 210 is configured to store failure and/or recovery data and metrics. This includes pre-failure data 402, which can correspond to data leading up to a failure and failure data 404, corresponding to data taken at the time of failure. The event database 210 also can include recovery event data 406, where the recovery event data can include information such as a unique recovery action 420, an action execution time 422, an action result 424, and the number of retries/execution count 426.

An illustrative example of one kind of pre-failure data is shown in FIG. 7, which is a first table 700 showing an illustrative example of a set of recovery data for several components of the storage arrays subsystem 204 of FIG. 2. Referring briefly to FIG. 7, it can be seen that for the component labeled FRU_1, there is a series of time stamped data having a certain recovery code (TMP for a temperature error), indicating that the FRU_1 component had a temperature that was higher than a predetermined value at those times, leading to an overtemperature condition, which led to a TMP-R (reset temperature) recovery action. This data in the table of FIG. 7 shows that there is pre-failure data up to the 6:15:00 AM timestamp, after which there are two different actual failures from which the device FRU_1 did not recover. In addition, FIG. 7 includes dynamically computed (real-time) likelihood of failure metric 222, which the time sequence machine learning model 208 determines in a real-time, ongoing basis, based on information in the event database 210. As will be understood, in many instances, a dynamically computed, real-time likelihood of failure metric can be monitored to observe its progression, where a pattern of the likelihood of failure metric going from better to worse can be an indicator of a developing or existing problem. As FIG. 7 shows, the likelihood of failure metric 222 increases (on a 0 to 100 scale) as the pre-failure data shows that the given event (TMP) is occurring more frequently and then number of retries to recover from failure is increasing. Of course, the data in the table of FIG. 7 is simplified, shown for illustrative purpose only, and in a real-world example there would be many more data points, types of data, and time stamps, but the example of FIG. 7 is intended to show some of the principles of operation of the predictive system 202. Those of skill in the art will realize that many different types of pre-failure data 402 can be considered, based on a given application. These and other types of pre-failure data are also usable to train the model and also can be part of training database 212.

Referring again to FIG. 4, the event database 210 also includes performance metrics data 408, which includes part install date 428, part run time 430, response times 432, error rates 434, and throughput 436. These examples of types of data are illustrative and not exhaustive. Referring briefly to FIG. 8, FIG. 8 is a second table 800 showing an illustrative example of performance metrics for several components of the second storage array system 200 of FIG. 2, in accordance with one embodiment. As the second table 800, the time sequence machine learning model 208 has computed another type of likelihood of failure metric (LOFM) 222 for each FRU component, based at least in part on some of the performance data (and optionally based on other data, such as pre-failure data, data from other systems, etc.). The second table 800 shows that several parts with an error rate per 100 hours run time that exceeds 1.5, generally were classified as having a “high” LOFM. Several parts with an error rate below 1.0 generally were classified as a “low” LFM, but one part (FRU_7) was listed as having a “high” LOFM even with an error rate below 1.0, because of its more recent install time and low run time, indicating perhaps that, based on information from the event database 210 and/or training database 212 regarding parts of this age and run time, that such parts generally should not have that level of an error rate, so the time sequence machine learning model 208 computed an LOFM of “High” for FRU_7, indicating that an earlier than normal failure is predicted for FRU_7. Similarly, for FRU_5, despite the error rate being in the “average” range of 1.0 to 1.5, the time sequence machine learning model 208 determined an LOFM of “Avg-High” for FRU_5 because this component is regularly being run with very high throughput, indicating that it is being run at a higher rate than typical devices of its type and age. Again, these examples are illustrative, and not limiting.

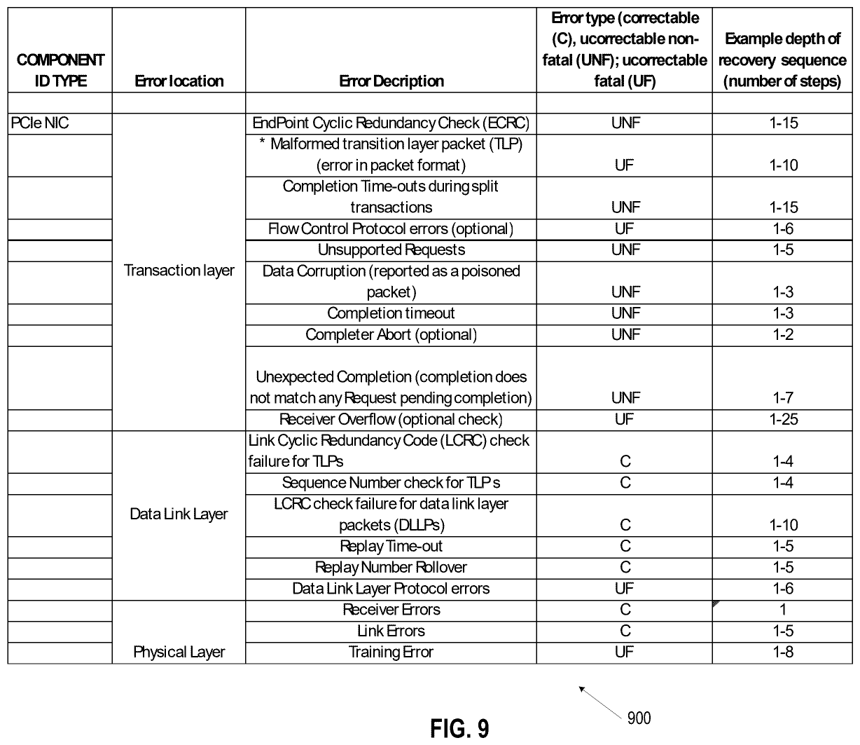

Other types of data also can be considered as part of pre-failure data, failure data, and/or performance data, such as how deep into a recovery sequence an event has to go to recover. For example, FIG. 9 is a third table 900 showing illustrative error information for a first exemplary component of the storage array system of FIG. 2, in accordance with one embodiment. In the example of FIG. 9, the component is a PCIe NIC (peripheral component interconnection express network interface card). One column of the table shows error location (e.g., transaction layer, data link layer, physical layer), one column shows, error description, one column shows error type (e.g., correctable, uncorrectable non-fatal, uncorrectable fatal) and a corresponding depth of recovery sequence (number of steps). Information about the recovery sequence, such as the depth reached and whether it resulted in a recovery, are further kinds of pre-failure and/or failure information that can be tracked in the event database 210 and/or the training database 212, in certain embodiments. Having information about the depth of recovery and/or what happens at a given recovery step can provide the time sequence machine learning model 208 with extra granularity in data for its analysis and predictions of likelihood of failure.

As an example of how depth of recovery information (including progress through a recovery sequence and how far or “deep” the progress is into the recovery sequence) is useful in analysis, consider an exemplary FRU, which in this example is a PCIe. A PCIe has a three layered architecture for communication between two devices, with the three layers being a transaction layer, a data link layer, and a physical layer. Various types of errors can occur on any of the layers, and the errors can be further classified based on severity (correctable errors, uncorrectable non-fatal errors, and uncorrectable fatal errors). In addition, within each error type, there may be one or more corresponding recovery flow sequence(s) (e.g., one or more predetermined recovery flows) for correcting (or attempting to correct) such an error, with varying degrees of intervention that can take place, where these degrees of intervention may take place silently before any tangible error or excursion event (deviation from normal operation flow) is finally reported in a log.

In certain embodiments, for software, hardware, and/or systems that have arrangements where there are multiple types of recovery events, degrees of intervention within a recovery process, types of errors, etc., it can be useful to be able to analyze not just error log data, but also data that can show how far into a given recovery algorithm a recovery had to go, including optionally time spent, and how many times this might have happened, before an actual error gets logged. This can help give further insight into predicting software, hardware, and/or system failures.

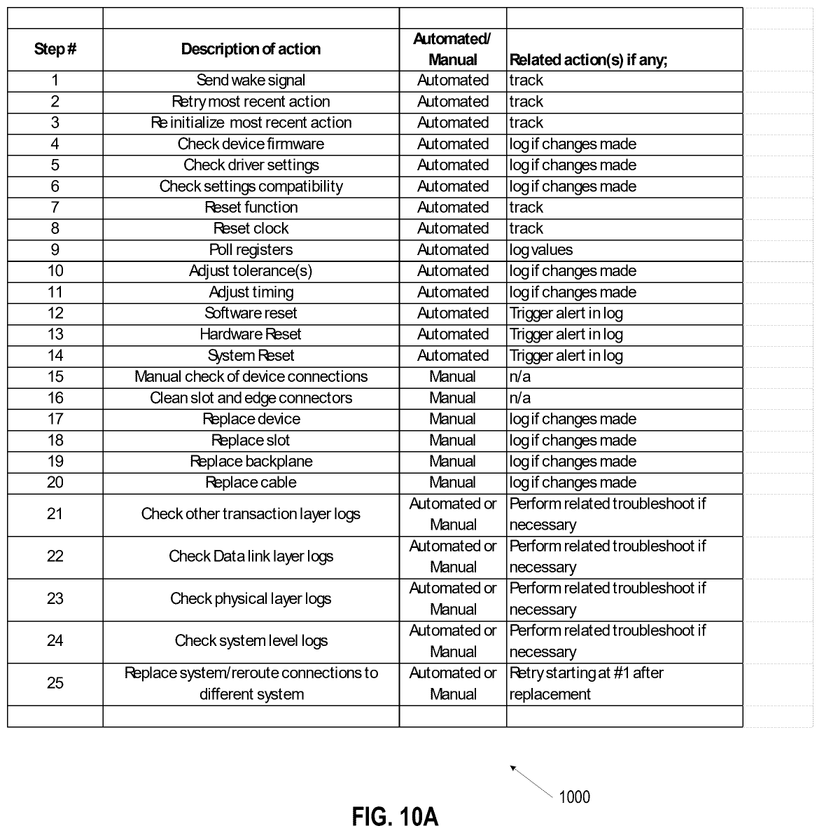

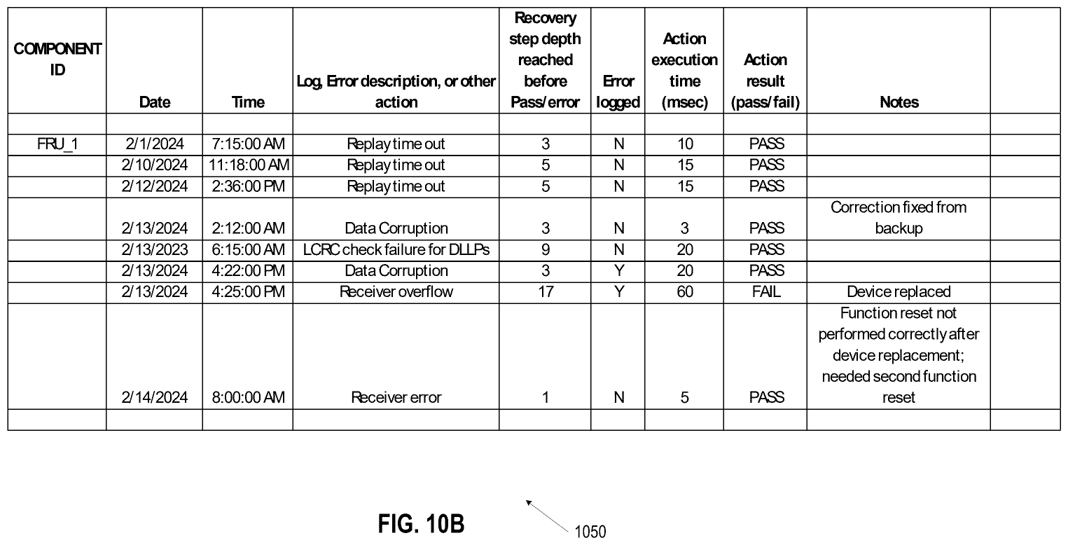

Referring still to FIG. 9, it can be seen that the depth of recovery sequence in this illustrative example of a PCIe can vary based on the error type and layer where the error is located, though this is not limiting or required. As an example, the receiver overflow error, which the third table 900 lists as an “uncorrectable fatal” error, has a recovery sequence of 25 steps, and the event database 210 and/or the training database 212 can track how far into the recovery sequence a system has to go to recover from a given event, as well as to track the type of recovery action, execution time, etc., as discussed above in FIG. 7. FIG. 10A is a fourth table 1000 showing an illustrative flow of the 25 recovery steps for the receiver overflow error, in accordance with one embodiment. One column of the fourth table 1000 FIG. 10A shows step number, the next column shows a description of the action to be attempted at that step, the next column indicates whether the action in automated action or a manual action (i.e., requiring operator intervention), and the last column provides related actions, such as the type of tracking, logging, alerts, and/or troubleshooting that also is associated with the step. Although not indicated in the fourth table 1000, in certain embodiments, the recovery sequence loops back to a retest of the issue after a later step is done, then proceeds to start again at recovery sequence step 1 if the error happens again. In other embodiments, after certain predetermined steps in the recovery sequence, a retest or looping may instead jump to a different earlier step or even a later step, as will be understood, dependent on the application, the first step after a later step is done.

The event database 210 and/or the training database 212, in certain embodiments, can track a history of the recovery depths for a series of errors for a given component. For example, FIG. 10B is a fifth table 1050 showing an illustrative set of recovery information for a given FRU in the second storage array system 200 of FIG. 2, which can be representative of the type of recovery information stored in these databases. In this example, the FRU (“FRU_1”) corresponds to a PCIe NIC having the set of error types of FIG. 9 and the exemplary recovery sequences of FIG. 10B. As FIG. 10B illustrates, the illustrative set of recovery information includes both pre-failure data and failure data. The data in fifth table 1050 includes respective columns showing component identifier, data of event, time of event, log error description or other action, recovery step depth reached before pass/error, whether an error was logged, action execution time, action result, and notes if applicable. It can be seen in the fifth table 1050 that, over a period of approximately two weeks, the FRU_1 component had the same error happen (“replay time out”) a few times in a row which error, per the third table 900 of FIG. 9 is a correctable error having a recovery sequence of 5 steps. The first time the error occurred, the recovery only needed to reach the third step, but the third and fourth times the error occurred, the recovery needed all 5 steps. Additional other types of errors and recoveries took place, until an unrecoverable fatal Receiver overflow error, which stopped at step 17 in the recovery sequence of FIG. 10A, a step with an action of replacing the device. There was a minor error after this step, then the FRU_1 passed.

As those of skill in the art will appreciate, machine learning models such as the time sequence machine learning model 208 of FIG. 4, can be configured to analyze data for many hundreds of thousands (or more) of data, data sequences, etc., similar to those shown in FIG. 10B. For example, the data sequence shown in FIG. 10B, when repeated for multiple FRUs over multiple time periods, can help to train the time sequence machine learning model 208 to recognize patterns of errors that can lead to need for a device replacement, for FRUs similar to FRU_1. Based on what is learned from data such as that in FIG. 10B, the time sequence machine learning model 208 may recognize that a series of certain type of error (e.g., the replay time out errors of FIG. 10B), with worsening recovery step depth, are likely to precede an imminent failure of a component having features similar to FRU_1. Other factors, such as performance metrics (e.g., of FIG. 8) also can be part of this analysis. The predictive actions, including the likelihood of failure metric 222, enable taking preventative automated and/or manual FRU sparing actions to prevent or mitigate other kinds of failures, equipment downtime, etc. An exemplary process for how this is done, in certain embodiments, is discussed further in connection with the method of FIG. 6A, which is discussed further herein.

Referring again to the predictive system 202 of FIG. 4, the time sequence machine learning model 208 includes one or more modules to implement its functionality. The modules shown in FIG. 4 are exemplary and not limiting and many different types and implementations of time series machine learning models are usable. The exemplary time sequence machine learning model 208 of FIG. 4 includes a pre-processing/data cleaning module 438, an aggregation module 440, a segmentation module 441, a weighting module 442, a classification module 444, a clustering module 446, a machine learning algorithm module 448, a prediction/metric generation module 450, and an optional database of computed LOFMs 452 that is indexed to device/FRU. Not all of these modules are used or are necessary in all embodiments, as will be appreciated.

The pre-processing/data cleaning module 438 is configured to adjust raw data so that it is suitable for further processing, such as eliminating duplicate data, removing or adjusting for data anomalies and outliers, handle/compensate for missing values and/or discontinuities in data (e.g., via interpolation based on other data), synchronizing/normalizing time stamps (e.g., for data that might be from different time zones or in different time formats), smoothing noise (if applicable to the type of data), etc. The pre-processing/data cleaning module 438 thus has an effect, in some instances, of filtering the raw data.

The aggregation module 440 is configured to combine multiple pieces of data into one or more smaller data sets, along predetermined or specified “dimensions” (e.g., time) or in alignment with any predetermined value or characteristic, such as alignment based on consistent time intervals. For example, data can be aggregated into other time units, such as all data taken from a module or system within a given week or month, etc. The aggregation module 440 also can be configured to consider a rolling aggregated time window, such as review of the most recent recovery events for any given component. As is understood, this process can help to simplify, speed up and/or reduce further data processing.

The segmentation module 441 can operate in a complementary way to the aggregation module 440, because the segmentation module 441 is configured to take time series of data and split it into segments. As is understood in the art, the splitting of the time series data into segments can help to reveal underlying properties of the source. For example, in the context of analyzing recovery sequence data, segmentation can be useful when considering large amounts of data from multiple sensors of a system, where the sensor behavior can help to reveal an underlying problem with a system and/or with components in a system.

The weighting module 442, as its name implies, is configured to assign more importance to certain data based on one or more predetermined factors that may be important in a given application. For example, recovery data that is from components or units that are from the same “lot number” or are approximately the same age, as a given part for which a prediction is going to be made, may be given more weight in a data set than data that are for the same type of component, but which are from a different lot number or which have a different age.

The classification module 444 is configured to help assign or predict a classification to a previously unseen time series of data, based on the past data used to train the time sequence machine learning model 208. The functionality of the classification module can be useful when new or upgraded components are added to an existing system, where the new/upgraded component generates different data, data in a different formant, and/or runs different recovery sequences, as compared the data on which the time sequence machine learning model 208 was trained.

The clustering module 446 is configured to take many time series and aggregate them into clusters, e.g., using technique such as Dynamic Time Warping, which dynamically compares time series data and can compute a distance metric even when the time indices between comparison data points do not sync up perfectly. In the context of recovery sequences and failure data, the clustering module 446 can help to analyze time-based performance metrics, such as response times, throughput, etc., if they are not the same between different types of modules.

The machine learning algorithm module 448 is configured to implement the desired machine learning algorithm or technique in cooperation with the other modules within the time sequence machine learning module 208. As is understood, the time sequence machine learning model 208 can be implemented with many different types of time sequence machine learning model algorithm frameworks, including but not limited to one or more models based on statistical techniques and/or algorithms for machine learning such as the following, any of which are applicable in the various embodiments herein: RNN (Recurrent Neural networks), LSTM (Long Short-Term Memory, ARIMA (Autoregressive Integrated Moving Average), and/or SARIMA (seasonal auto-regressive integrated moving average. In certain embodiments, LSTM is advantageous for time sequence analysis, and some of the other models (e.g., ARIMA, SARIMA) are advantageous for analysis of metrics, especially layered on top of time sequence analysis.

The prediction/metric generation module 450 helps to automatically generate the actual likelihood of failure metric 222, based on information from and in cooperation with one of more of the modules of the time sequence machine learning module 208, as well as on information in the event database 210 and in the training database 212. In certain embodiments, the likelihood of failure metric 222 corresponds to a level or rating that is compared to a predetermined threshold level or rating, wherein the threshold represents a level or point wherein, if a component, system, process reaches it, that component, system, process, etc., is deemed likely to fail. In some embodiments, the value or setting of a given threshold can be based at least in part on data and/or events associated with actual failures, whether in the second storage array system 200 or in other systems/networks 220. Accordingly, in certain embodiments, to help prevent further failures (and/or consequences from further failures), marginal hardware that is approaching such a failure determined by the time sequence machine learning model 208, can be configured to be indicted at a level that is slightly reduced from the threshold level.

For example, in certain embodiments, the likelihood of failure metric 222 may take the form of a numerical value from 0 to 100, wherein the numerical value represents the chances of failure within a predetermined time (e.g., likelihood of failure of 70 corresponds to a 70% chance of failure within the next 100 hours of operating time, as an illustrative example). The likelihood of failure metric also could be represented by an indicator (e.g., red=high, yellow=average, green=low), or a word (high, medium, low) where that indicator is determined based on some or all data in the 2^{nd} information set. The previously discussed illustrative examples of FIGS. 7-8 show some examples of likelihood of failure metrics 222.

FIG. 5 is a more detailed block diagram of the storage arrays subsystem 204 of the second storage array system 200 of FIG. 2, in accordance with one embodiment. The embodiments herein are not limited to use with storage array systems like that of FIG. 5, but the storage arrays subsystem 204 is included as an illustrative example to show a source for data that the predictive system 202 can analyze and for providing controls and other information enabling actions to be taken to alter the operation of the storage arrays subsystem 204. Some of the signals automatically generated by the controller system 214 of the storage arrays subsystem 204 are conveyed via the storage bus 252 of FIG. 5 and include manual actions 262 (discussed previously in connection with FIG. 2) and automated operational controls 250 (discussed previously in connection with FIG. 2). Optional outputs of the storage arrays subsystem 204, as mentioned above include the first information set 226A that can include one or more of SA events, data points, data sequences, performance metrics, etc.

The storage arrays subsystem 204, in certain embodiments, includes a controller system 214 and one or more storage arrays 104A-104N, all in operable communication via the storage bus 252. The controller system 214 can be implemented based on a standard storage array controller system and adapted as described herein. In the embodiment of FIG. 5, the controller system 214 includes an SA operational control module 502, an SA polling process 504, a recovery/pre-failure event data collection and logs process 506, an RMA (return merchandise authorization)/failure event data collection and logs process 508, an FRU sparing control process 510, a a logical/physical isolation process 512, and a model tuning process 514. In certain embodiments, the controller system 214 also includes the predictive system 202 which automatically generates the likelihood of failure metric 222.

The SA operational control module 502 is configured to control operation of the storage arrays 104A-104N, including but not limited to tasks such as integrating the memory in the multiple storage arrays 104A to present them as a single memory area to an external server, writing data to and reading data from storage arrays 104A-104N, running maintenance and troubleshooting processes on the storage arrays 104A-104N, allocating capacity within the storage arrays 104A-104N, performing backups from the storage arrays 104A-104N to a backup system (not shown), taking disk snapshots, and many other standard storage controller tasks.

The SA polling process 504 is configured to poll the predictive system 202 to help determine, based on the LOFM 222, predicted failures, e.g., predicted failures of the storage arrays 104A-104N and/or any FRUs 526 within them. In certain embodiments, polling is done in several tiers, e.g., three tiers:
1) In a first tier, polling by the microcode itself, maintaining current values as reported by log files/registers
2) In a second tier, by the control station/service processor local to the storage array 104 (e.g., controller system 214, or any controller used for interfacing to the array) to aggregate local historical data and package the data for central collection, e.g., by an optional centralized processing such as optional processing module 206; and
3) In a third tier, via central collection from each array 104A-104N and stored into a big data lake (e.g., data lake 207)

In certain embodiments, similar polling processes can be run on any one or more of the host devices 130A-130N (FIG. 2), wherein any one or more of those host devices 130A-130N also could poll the predictive system 202 for predicted failures. This polling can be done periodically, randomly, upon request, upon occurrence of a specific action (e.g., a related failure or recovery event), as will be understood. For example, if the controller system 214 receives (e.g., via the continually tuned model information 224 provided by the processing module 205) information indicating that FRUs in other systems/networks 220 are experiencing a certain type of failure after a certain set of recovery actions, leading to certain LOFMs 222 coming from those other systems, the controller system 214 likewise can poll its predictive system 202 to see if, based on the data it has in its event database 210, it, too, may have respective LOFMs 222 indicating similar or related potential failures.

Referring again to FIG. 5, the recovery/pre-failure event data collection and logs process 506 is configured to collect normal operating data and to parse it for recovery events which may be part of “normal” data which may not yet have led to a failure or may not have led to an immediate failure) and to provide this data to the event database 210 of the predictive system 202. In some embodiments, this recovery/pre-failure data is included as part of the first information set 226A. In certain embodiments, the recovery/pre-failure event data collection and logs process 506 may be configured to collect only a subset of all normal operating data, as will be understood. As will be understood, it is advantageous to collect both normal data and failing/marginal data, to help flag failures and/or potential failures.

For example, in certain embodiments, care is taken to account for collecting data associated with normal operation of the system being monitored and not large scale events (e.g., system initialization and/or power loss) that could skew the data-and thus skew any resultant time sequence machine learning model 208 that is determined or tuned based at least in part on the collected data. Depending on the application, the type of normal operating data being collected can be configured to include data that is predetermined to be advantageous in helping to automatically generate the likelihood of failure metric 222. For example, the type of “recovery” and “pre failure” data that is collected includes, but is not limited to, the types of data and/or metrics shown and discussed above in connection with the discussion of the event database 210 and/or training database 212, as well as in FIGS. 7-10B, especially recovery data. Similarly, the recovery/failure event data collection and logs process 508 is configured to collect data on failures in the storage arrays subsystem 204, including recovery data that might be associated with those failures.

The RMA/failure event data collection and logs process 508 is configured to collect logs for use in subsequent hardware and other failure analysis processes. The FRU sparing control process 510 is responsive to the LOFM 222 to help signals from the FRU sparing control module 312 (FIG. 3) to help determine and/or cause the specific automated actions needed to help mitigate predicted failures, including by generating one or more automated operational controls 250 (e.g., control signals) that cause the determined actions to take place. In certain embodiments, the FRU sparing control process 510 receives the likelihood of failure metric 222 from the predictive system 202 and determines, based on its value, and/or based on one or more predetermined thresholds (which can vary based on device, application or other factors), whether any actions need to be taken within the second storage array system 200. For example, in certain embodiments, if the likelihood of failure metric 222 exceeds a predetermined threshold, the FRU sparing control process 510 initiates an automatic action within the second storage array system 200 that is configured to mitigate at least one impact of a possible failure of at least one component, FRU, etc. As will be appreciated, the automatic action is not necessarily an action that is done to the actual component predicted to fail. Instead, the automatic action could control other components (which are not necessarily indicted as being likely to fail) to cause these other components to bypass or take the place of the actual component predicted to fail, or to alter their operation or functions so that these components no longer need functionality from the component that is predicted to fail. For example, if one of several power supplies is predicted to fail, an automatic action could involve switching to backup power or battery backup, configuring other equipment (if possible) to run using a reduced voltage, etc.

The logical/physical isolation process 512 helps to initiate an automated FRU sparing action within the storage arrays subsystem 204, such as by sending signals to one or more of the storage arrays 104A-104N to effect at least one of logical and physical isolation of the predicted failure (e.g., the one or more components, systems, and/or processes) that are predicted to have a likelihood of failure metric 222 that exceeds, matches, or is approaching, a predetermined threshold.

In certain embodiments, the logical/physical isolation process 512 causes the logical and/or physical isolation to happen automatically, without human/operator intervention. For example, if failure of certain devices features of storage array SA2 104B is predicted, the logical/physical isolation process 512 causes actions that can mitigate or reduce impact of such failures via an automatic backup of all information on SA2 104B, taking snapshots, moving certain data to other storage arrays, reconfiguring to alleviate stress and/or chokepoints on individual components, preventing future reads to and writes from that storage array, automatically bypassing a device about to fail, reducing power to a device about to fail, minimizing operations on a device about to fail, gracefully shutting down a device about to fail, etc. Those of skill in the art will appreciate that the FRU sparing action can vary based on the type of device and the type of failure. In certain embodiments, the physical and/or logical isolation process 512 can provide a communication or alert to an administrator 216 or other operator, with a notification to take a particular one or more actions manually, such as manually replacing a piece of hardware, performing a manual adjustment of a tunable parameter, performing other troubleshooting, etc.

In certain embodiments (e.g., if a process like the physical and/or logical isolation process is running on a host device 130A-130N), the communication or alert can be provided to a user or operator of the host device 130A-130N. In another example, if a host device 130A-130N corresponds to a motor vehicle, and the predicted failure involves a certain aspect of the motor vehicle's electrical system, the physical and/or logical isolation process could cause automatic deactivation or alteration of certain functions (e.g., disabling use of a feature not essential for vehicle operation, such as audio speakers), to help minimize current draw and minimize the load being drawn on the malfunctioning electrical system in the motor vehicle, based on information that is received at the controller system 214.

The model tuning process 514 is configured to process data received in the time series databases (e.g., within the event database 210 and/or the training database 212), along with the LOFM 222, to provide information to adjust the time sequence machine learning model 208. As an example of how this works, consider a situation where certain recovery trends (and certain LOFMs 222) are noted for similar FRUs that are also present in other systems/networks 220, such as a series of recovery events, leading to a failure event, that is appearing in components having a certain age and operating under certain environmental conditions. The model tuning process 514 evaluates that information to provide adjustments to the time sequence machine learning model 208 that can be used to help tune the time sequence machine learning model 208 to produce more accurate LOFMs 222. Various aspects of the model can be tuned/adjusted, including how various functional modules (see FIG. 4) work, including but not limited to how data is aggregated and/or segmented, weighted, classified, clustered, which machine learning is algorithm used, etc. For example, in certain embodiments, modules within the time sequence machine learning model 108 undergo different types or amounts of weighting to increase sensitivity without creating false positives

As an example of tuning of the time sequence machine learning model 208, consider, for example, a device or FRU that could be used in various environments and applications, such as a particular graphics card, which could be used in motor vehicles, a manufacturing, in one or more of the host devices 130A-130N, etc. Assume that event data from the fourth information set 229 and/or the fifth information set 231 indicates that graphics cards over two years old, from a certain manufacturer, which are used a certain number of hours per month, are experiencing higher than average rates of failure and/or recovery events, when installed in motor vehicles operated in humid climates. Assume, as well, that one or more sensors also track data that include readings (e.g., humidity and/or other environmental factors, such as airborne particulate counts) that are taken into account at the time sequence machine learning model 208. An LOFM 222 can be generated automatically for similar FRUs in the storage arrays subsystem 204, or in other systems/networks 220, with the time sequence machine learning module 208 giving more weighting in its computations (e.g., in its machine learning algorithm) to graphics card data that even more closely tracks those failing in other systems (e.g., same lot number, etc.).

The fourth information set 229 of data from other systems/networks 220 also can be used to tune the time sequence machine learning model 208 to consider or look for similar factors (e.g., graphics card age, usage, operating environment) when processing data on the same or similar graphics cards used in the host devices 130A-130N and/or in the storage arrays subsystem 204, as part of generating the LOFM 222. This data may be used not only to predict parts likely to fail but, based on the nature of the failures, suggest the type of automated and/or manual actions that could reduce or eliminate a need for complete part replacement, via as isolation of the part, automated or manual inspection of certain features of the part (e.g., to determine if corrosion or other damage is present), and other actions, as those of skill in the art will appreciate. As will be appreciated, even if those systems being used to tune the time sequence machine learning module 208 are different types of systems, pertinent parts of that data can be parsed to provide as data for the training database 212 and/or data that can be used to adjust the model time sequence machine learning model 208.

Referring still to FIG. 5, an exemplary storage array 104, such as SA1 104A, includes a storage processor 102A, a storage device 114A (including a storage array controller 550A and a storage medium 552A), a scan/self-test process 520A, a polling task 522A, a recovery process 524A, and a plurality of FRUs (e.g. FRU₁ 526A_1 through FRU_{N} 526A_N). Several of these components were described already in connection with FIG. 1 and their description is not repeated here. The scan/self-test process 520 is configured to perform the self-test and other similar actions that generate the actual data (e.g., register scans, reading values from sensors, measuring power levels and/or signal strengths, etc.) that is provided to the controller system 214's logs via storage bus 252. The polling task 522A cooperates with the SA polling process 504 of the controller system 214 to provide the data and other information being requested. The recovery process 524A is what executes the various recovery sequences (e.g., those detailed in FIGS. 9-10B, as discussed previously). The FRUs 526, in certain embodiments, correspond to any devices or hardware that can be subject to recovery sequences and/or failures, but this is not limiting. FRUs not directly associated with recovery sequences also can be impacted by the LOFM 222, as will be appreciated.

FIG. 6A is a first exemplary flowchart 600 of a method of using recovery information to automatically generate likelihood of failure metrics configured to identify and predict failing and/or marginal hardware, usable in the storage array systems of FIGS. 1 and 2, in accordance with one embodiment. Many of the actions in this flowchart have been described above, especially in connection with FIGS. 2-5. Normal system operations are monitored (block 605) and, as part of this, the predictive system 202 receives into the appropriate database(s) (block 610) events (e.g., SA events), data points, data sequences, performance metrics, and failure information (if applicable) and this information is provided to the event database 210 and/or the training database 212 (block 615). Advantageously, the events etc. are tracked locally. Additionally, inputs to the time sequence machine learning model 208 are retrieved/provided, including a set of additional performance metrics (block 620), e.g., as shown in performance metrics data 408 (FIG. 4). If a recovery event or a failure is not detected in the received information (i.e., if the answer at block 625 is NO), processing returns to monitoring system operations (block 605).

If a recovery event or a failure is detected in the received information (answer at block 625 is YES), then processing moves to block 630, where the specific set of recovery event data and/or other recovery event information is retrieved from the appropriate database(s) (and/or from the storage array 104, if applicable) (block 630). In certain embodiments, to retrieve the set of recovery data, the event database 210 is queried for a recovery set of data points (block 635), such as unique recovery actions 420, unique action execution time 422, an action result 424, and execution count (i.e., retries) 426. In addition, the event database 210 and/or the storage arrays subsystem 204 are queried for a set of performance metrics (block 640), e.g., the performance metrics data 408 of FIG. 4. The recovery event data (and/or other recovery event information) of blocks 630-635 and the performance metrics data 408 are FIG. 4 are provided and processes within the time sequence machine learning model 208 (block 645) to automatically generate the likelihood of failure metric 222 (block 645), which model has been trained using data from failing parts in the training database 212 (block 647). As discussed previously, the likelihood of failure metric 222 is a representation, in a desired format, of the odds of failure of a device/FRU, etc., wherein a predetermined threshold can be set to determine when action needs to be taken (e.g., if the likelihood of a failure metric is close to, equal to, or greater than, the predetermined threshold.

Referring again to FIG. 6A, logs of the data are provided to an existing RMA process (e.g., RMA/failure event data collection and logs process 508 of FIG. 5) (block 650) for use in subsequent hardware failure analysis processes and/or simulation and testing of recovery sequences (as discussed in FIG. 6B, below). A polling task (e.g., SA polling process 504 of FIG. 5) polls for predicted failures based on the LOFM 222 (block 655). If there are predicted failures (answer at block 660 is YES), then automated FRU sparing actions are initiated, if possible (block 665), e.g., via FRU sparing control process 510 (FIG. 5) or other appropriate actions are taken (e.g., if FRU sparing actions are not possible), and then processing moves to block 670 to tune the time sequence machine learning model 208 based on the updated failure/recovery information determined in blocks 625-665. In addition, if necessary, the threshold (e.g., for the LOFM 222) is retuned (e.g., adjusted), if needed (block 673), e.g., based on data and/or information similar to that used to tune the time sequence machine learning model 208. If there were no predicted failures (answer at block 660 is NO), processing moves to block 675, which is also the next block after retuning the threshold if needed. In block 675, there is centralized processing to aggregate the data logs, model tuning, etc., optionally to send to other systems/networks 220.

Another application of the advantageous time sequence machine learning model 208 involves replicating or recreating symptoms of a failure mode and/or pre-failure conditions, to help exercise recovery code routines and sequences and other types of troubleshooting, as well as to help discover new symptoms that can lead to known problems. The replications or recreation of a failure, in certain embodiments, can serve as a “replay” feature for sequences that result in a failure. This can enable existing testing and simulation to be improved and new modes of testing to be implemented to improve quality engineering (QE) processes, to help improve reliability metrics. For example, FIG. 6B is a second exemplary flowchart 680 of a method of using the likelihood of failure metrics automatically generated in FIG. 6A to help exercise recovery sequences, in accordance with one embodiment. Referring to FIG. 6B, a set of failure information is received at a computer processing system configured to perform system simulation testing (block 682), where this information is information for which a desired recovery sequence is being developed, or exists, and wherein developers want to determine how well the recovery sequence works to compensate for or mitigate the issues leading to or arising from the failure. Based on the failure information (e.g., a particular component or device that has failed or whose failure is being simulated), the predictive system 202 is polled to determine if any LOFM metrics 222 are associated with any of the received failure information-e.g., have any past LOFM metrics 222 been computed for any of the components whose failure is being simulated for exercise of recovery sequences. In certain embodiments, this information is stored in the optional database of computed LOFMs 452 (FIG. 4).

Referring again to FIG. 6A, if there are no LOFM metrics 222 matches (answer at block 686 is NO) then processing ends for that failure information. If there are LOFM metrics 222 matches (answer at block 686 is YES), then, for each LOFM metric 222 match, the information associated with that LOFM metric 222 match is retrieved to obtain the corresponding conditions and/or events associated with the probable or actual failure (block 688). Based on that information, a testing/simulation system (not illustrated, but well understood in the art) is configured to be set up to match at least a portion of the corresponding conditions and/or events associated with the probable or actual failure (block 690). For example, a simulation system could be configured to simulate operational conditions associated with a given likelihood of failure metric 222. The recovery process/recovery flow is then run on the simulation/test system for that failure (block 692). If the recovery flow allows recovery from the failure, pre-failure, or other condition (answer at block 694 is YES), then processing is done for that set of failure information. If the recovery flow does not allow recovery from the failure (and assuming the failure is of a type where a recovery flow is theoretically possible) (answer at block 694 is NO), then the recovery flow is retuned (i.e., automatically adjusting the recovery flow based on results of exercising it in the simulation system) (block 696) and retried back at block 692.

The above-described arrangements provide multiple advantages in improving system operations, helping to reduce or eliminate the impact of marginally operating components or devices which may continue to run undetected in a system, until they cause a seemingly “unexpected” failure. With the arrangements described herein, the potential for such failures, and the record of issues leading up to such failures, can be better tracked. With at least some of the embodiments discussed herein, a complete recovery action historical record and signature will exist prior to and including the time of failure. This technique is in sharp contrast to current industry approaches, which can revolve around collecting information only after a failure has occurred, at which time the data may not be available and the components state will simply be “failed.”

At least some embodiments herein, as discussed above, enable collecting pre-failure data and generating signatures, such as the LOFM metric 222, ahead of hard failures, which allows better anticipation of future failures. This can help to reduce or eliminate greater system level impacts to the customer. Additionally, current approaches can rely on massive log collection and parsing out relevant data. In contrast, at least some embodiments herein can provide a better view into component behavior without the need to manually sift through vast amounts of data, by focusing on pre-failure data associated with recovery events, recovery event data, recovery event information and recovery event sequences, which can help provide insights into marginally failing or soon-to fail components and systems. With a more refined data set generated using at least some embodiments herein, a direct reduction in cost of service is expected due to a reduction of investigation and diagnosis hours.

Methods currently being used can require multiple part replacements over multiple site visits to determine the root cause of an issue. Better diagnosis of failures, using the arrangements described herein, can result in a reduction in site visits to replace parts by helping to minimize or eliminate at least some of the guess work from failure diagnosis. Another advantage of the embodiments described herein is that the time sequence machine learning model 208 does not need to know state machines of individual recovery algorithms allowing for analysis across multiple functional code areas maintained by independent development teams. This can allow for non-subject matter experts to deal with the pre-failure and failure issues, reducing escalation costs into higher level engineering teams, because the arrangement can offer a simple instruction or alert (or perform one automatically) based on a straightforward LOFM metric 222, instead of requiring a subject matter expert to understand the details of the test result and being able to interpret what a marginal or failing value looks like. In some embodiments, having a time sequence machine learning model 208 that predicts likelihood of failure as a percentage, it is possible to set failure thresholds that allow servicing of a part before hard failure is reached.

The embodiments described herein have many applications, as will be appreciated. For example, any code base that includes recovery algorithms could benefit from sequence detection of certain signatures preceding hardware failure events in order to reduce impact or system downtime. It also is expected that the embodiments herein can be combined with and/or adapted to work with arrangements described in the following commonly assigned patents, which are hereby incorporated by reference:
U.S. Pat. No. 10,853,190 to Kumar et al., entitled “System and Method for a Machine Learning Based Smart Restore Mechanism,” issued on Dec. 1, 2020;
U.S. Pat. No. 11,227,222 to Vishwakarma et al., entitled “System and Method for Prioritizing and Preventing Backup Failures,” issued on Jan. 18, 2022;
U.S. Pat. No. 11,488,045 to Calmon et al, entitled “Artificial Intelligence Techniques for Prediction of Data Protection Operation Duration,” issued on Nov. 1, 2022;
U.S. Pat. No. 11,599,402 to Vishwakarma et al., entitled “Method and System for Reliably Forecasting Storage Disk Failure,” issued on Mar. 7, 2023;
U.S. Pat. No. 11,663,290 to Vishwakarma et al., entitled “Analyzing Time Series Data for Sets of Devices Using Machine Learning Techniques,” issued on May 30, 2023; and
U.S. Pat. No. 11,921,570 to Perneti et al., entitled “Device Failure Prediction Using Filter-Based Feature Selection and a Conformal Prediction Framework,” issued on Mar. 5, 2024.

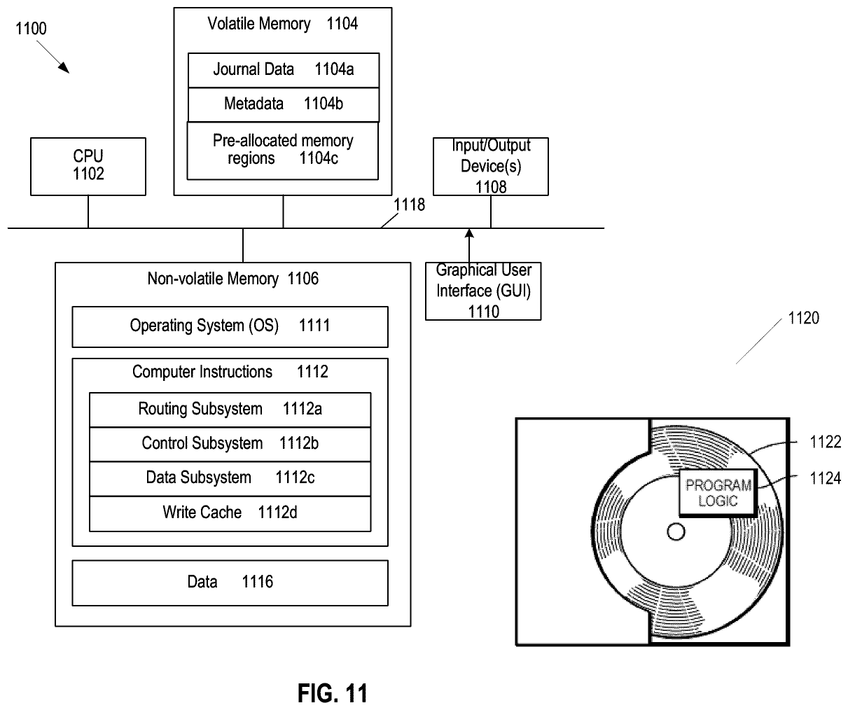

FIG. 11 is a block diagram of an exemplary computer system usable with at least some of the systems, methods, examples, and outputs of FIGS. 1-10B, in accordance with one embodiment. FIG. 11 is a block diagram of an exemplary computer system 1100 usable with at least some of the systems and apparatuses of FIGS. 1-10B, in accordance with one embodiment. Reference is made briefly to FIG. 11, which shows a block diagram of a computer system 1100 that is usable with at least some embodiments. The computer system 1100 also can be used to implement all or part of any of the methods, systems, and/or devices described herein.

As shown in FIG. 11, computer system 1100 may include processor/central processing unit (CPU) 1102, volatile memory 1104 (e.g., RAM), non-volatile memory 1106 (e.g., one or more hard disk drives (HDDs), one or more solid state drives (SSDs) such as a flash drive, one or more hybrid magnetic and solid state drives, and/or one or more virtual storage volumes, such as a cloud storage, or a combination of physical storage volumes and virtual storage volumes), graphical user interface (GUI) 1110 (e.g., a touchscreen, a display, and so forth) and input and/or output (I/O) device 1108 (e.g., a mouse/keyboard 1150, a camera 1152, a microphone 1154, speakers 1156 and optionally other custom sensors 1158, providing user input, such as biometric sensors, accelerometers, position sensors, etc.). A bus 1118 interconnects the CPU 1102, volatile memory 1104, non-volatile memory 1106, GUI 1110, I/O devices 1108, speakers 1156, keyboard/mouse 1150, camera 1152 (e.g., webcam), microphone 1154, and/or other custom sensors 1158.

Non-volatile memory 1106 stores, e.g., journal data 1104a, metadata 1104b, and pre-allocated memory regions 1104c. The non-volatile memory, 1106 can include, in some embodiments, an operating system 1114, and computer instructions 1112, and data 1116. In certain embodiment, the non-volatile memory 1106 is configured to be a memory storing instructions that are executed by a processor, such as processor/CPU 1102. In certain embodiments, the computer instructions 1112 are configured to provide several subsystems, including a routing subsystem 1112A, a control subsystem 1112b, a data subsystem 1112c, and a write cache 1112d. In certain embodiments, the computer instructions 1112 are executed by the processor/CPU 1102 out of volatile memory 1104 to implement and/or perform at least a portion of the systems and processes shown in FIGS. 1-13. Program code (e.g., computer program code) also may be applied to data entered using an input device or GUI 1110 or received from I/O device 1108.

The systems, architectures, and processes of FIGS. 1-11 are not limited to use with the hardware and software described and illustrated herein and may find applicability in any computing or processing environment and with any type of machine or set of machines that may be capable of running a computer program. The processes described herein may be implemented in hardware, software, or a combination of the two. The logic for carrying out the methods discussed herein may be embodied as part of the system described in FIG. 11. The processes and systems described herein are not limited to the specific embodiments described, nor are they specifically limited to the specific processing order shown. Rather, any of the blocks of the processes may be re-ordered, combined, or removed, performed in parallel or in serial, as necessary, to achieve the results set forth herein.

Processor/CPU 1102 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs). In some embodiments, the “processor” may be embodied in one or more microprocessors with associated program memory. In some embodiments, the “processor” may be embodied in one or more discrete electronic circuits. The “processor” may be analog, digital, or mixed-signal. In some embodiments, the “processor” may be one or more physical processors or one or more “virtual” (e.g., remotely located or “cloud”) processors.

Various functions of circuit elements may also be implemented as processing blocks in a software program. Such software may be employed in, for example, one or more digital signal processors, microcontrollers, or general-purpose computers. Described embodiments may be implemented in hardware, a combination of hardware and software, software, or software in execution by one or more physical or virtual processors.

Some embodiments may be implemented in the form of methods and apparatuses for practicing those methods. Described embodiments may also be implemented in the form of computer program code, for example, stored in a storage medium, loaded into and/or executed by a machine, or transmitted over some transmission medium or carrier, such as over electrical wiring or cabling, through fiber optics, or via electromagnetic radiation. A non-transitory machine-readable medium may include but is not limited to tangible media, such as magnetic recording media including hard drives, floppy diskettes, and magnetic tape media, optical recording media including compact discs (CDs) and digital versatile discs (DVDs), solid state memory such as flash memory, hybrid magnetic and solid-state memory, non-volatile memory, volatile memory, and so forth, but does not include a transitory signal per se. When embodied in a non-transitory machine-readable medium (e.g., a non-transitory computer readable storage medium) and the computer program code is loaded into and executed by a machine, such as a computer, the machine becomes an apparatus for practicing the method.

When implemented on one or more processing devices, the computer program code segments combine with the processor to provide a unique device that operates analogously to specific logic circuits. Such processing devices may include, for example, a general-purpose microprocessor, a digital signal processor (DSP), a reduced instruction set computer (RISC), a complex instruction set computer (CISC), an application specific integrated circuit (ASIC), a field programmable gate array (FPGA), a programmable logic array (PLA), a microcontroller, an embedded controller, a multi-core processor, and/or others, including combinations of one or more of the above. Described embodiments may also be implemented in the form of a bitstream or other sequence of signal values electrically or optically transmitted through a medium, stored magnetic-field variations in a magnetic recording medium, etc., generated using a method and/or an apparatus as recited in the claims.

For example, when the computer program code is loaded into and executed by a machine, such as the computer of FIG. 11, the machine becomes an apparatus for practicing one or more of the described embodiments. When implemented on one or more general-purpose processors, the computer program code combines with such a processor to provide a unique apparatus that operates analogously to specific logic circuits. As such a general-purpose digital machine can be transformed into a special purpose digital machine. FIG. 11 shows Program Logic 1124 embodied on a computer-readable medium 1120 as shown, and wherein the Logic is encoded in computer-executable code thereby forms a Computer Program Product 1122. The logic may be the same logic on memory loaded on processor. The program logic may also be embodied in software modules, as modules, or as hardware modules. A processor may be a virtual processor or a physical processor. Logic may be distributed across several processors or virtual processors to execute the logic.

In some embodiments, a storage medium may be a physical or logical device. In some embodiments, a storage medium may consist of physical or logical devices. In some embodiments, a storage medium may be mapped across multiple physical and/or logical devices. In some embodiments, storage medium may exist in a virtualized environment. In some embodiments, a processor may be a virtual or physical embodiment. In some embodiments, a logic may be executed across one or more physical or virtual processors.

For purposes of illustrating the present embodiments, the disclosed embodiments are described as embodied in a specific configuration and using special logical arrangements, but one skilled in the art will appreciate that the device is not limited to the specific configuration but rather only by the claims included with this specification. In addition, it is expected that during the life of a patent maturing from this application, many relevant technologies will be developed, and the scopes of the corresponding terms are intended to include all such new technologies a priori.

The terms “comprises,” “comprising”, “includes”, “including”, “having” and their conjugates at least mean “including but not limited to”. As used herein, the singular form “a,” “an” and “the” includes plural references unless the context clearly dictates otherwise. Various elements, which are described in the context of a single embodiment, may also be provided separately or in any suitable subcombination. It will be further understood that various changes in the details, materials, and arrangements of the parts that have been described and illustrated herein may be made by those skilled in the art without departing from the scope of the following claims.

Throughout the present disclosure, absent a clear indication to the contrary from the context, it should be understood individual elements as described may be singular or plural in number. Additionally, terms such as “input,” “output,” “message” and “signal” may refer to one or more currents, one or more voltages, and/or a data signal. Within the drawings, like or related elements have like or related alpha, numeric or alphanumeric designators. Further, while the disclosed embodiments have been discussed in the context of implementations using discrete components, including some components that include one or more integrated circuit chips), the functions of any component or circuit may alternatively be implemented using one or more appropriately programmed processors, depending upon the signal frequencies or data rates to be processed and/or the functions being accomplished.

Similarly, in addition, in the Figures of this application, in some instances, a plurality of system elements may be shown as illustrative of a particular system element, and a single system element or may be shown as illustrative of a plurality of particular system elements. It should be understood that showing a plurality of a particular element is not intended to imply that a system or method implemented in accordance with the disclosure herein must comprise more than one of that element, nor is it intended by illustrating a single element that the any disclosure herein is limited to embodiments having only a single one of that respective elements. In addition, the total number of elements shown for a particular system element is not intended to be limiting; those skilled in the art can recognize that the number of a particular system element can, in some instances, be selected to accommodate the particular user needs.

In describing and illustrating the embodiments herein, in the text and in the figures, specific terminology (e.g., language, phrases, product brands names, etc.) may be used for the sake of clarity. These names are provided by way of example only and are not limiting. The embodiments described herein are not limited to the specific terminology so selected, and each specific term at least includes all grammatical, literal, scientific, technical, and functional equivalents, as well as anything else that operates in a similar manner to accomplish a similar purpose. Furthermore, in the illustrations, Figures, and text, specific names may be given to specific features, elements, circuits, modules, tables, software modules, systems, etc. Such terminology used herein, however, is for the purpose of description and not limitation.

Although the embodiments included herein have been described and pictured in an advantageous form with a certain degree of particularity, it is understood that the present disclosure has been made only by way of example, and that numerous changes in the details of construction and combination and arrangement of parts may be made without departing from the spirit and scope of the described embodiments. Having described and illustrated at least some the principles of the technology with reference to specific implementations, it will be recognized that the technology and embodiments described herein can be implemented in many other, different, forms, and in many different environments. The technology and embodiments disclosed herein can be used in combination with other technologies. In addition, all publications and references cited herein are expressly incorporated herein by reference in their entirety. Individual elements of different embodiments described herein may be combined to form other embodiments not specifically set forth above. Various elements, which are described in the context of a single embodiment, may also be provided separately or in any suitable sub-combination.

1. A computer-implemented method, comprising:
receiving, upon occurrence of a first recovery event associated with a corresponding one of a plurality of components in a first system, a first set of corresponding recovery event data;
retrieving a set of first corresponding performance metrics associated with the corresponding one of the plurality of components;
providing the first set of corresponding recovery event data and the first set of corresponding performance metrics to a first time sequence machine learning model, the first time sequence machine learning model configured to analyze the first set of corresponding recovery event data and the first set of corresponding performance metrics to generate a first likelihood of failure metric for the corresponding one of the plurality of components in the first system; and
initiating, if the first likelihood of failure metric exceeds a first threshold, automatic generation of a first control signal configured to initiate an automatic action within the first system configured to mitigate at least one impact of a possible failure of the corresponding one of the plurality of components.

2. The computer-implemented method of claim 1, wherein the automatic action is configured to trigger at least one of logical and physical isolation of the corresponding one of the plurality of components.

3. The computer-implemented method of claim 1, wherein the first time sequence machine learning model is trained using failure data associated with one or more other components having one or more characteristics in common with the corresponding one of the plurality of components of the first system.

4. The computer-implemented method of claim 1, wherein the first time sequence machine learning model is tuned based on at least one of the first set of corresponding recovery event data and the first likelihood of failure metric.

5. The computer-implemented method of claim 4, further comprising:
continually tuning the first time sequence machine learning model based on at least one of the first set of recovery event data and the first likelihood of failure metric and a second recovery event information and one or more second likelihood of failure metrics, wherein the second recovery event information and the one or more second likelihood of failure metrics are generated in and communicated by a second system that is in operable communication with the first system.

6. The computer-implemented method of claim 1, further comprising at least one of setting a value and adjusting a value of the first threshold based on at least one of pre-failure event data and failure event data of the first system.

7. The computer-implemented method of claim 1, further comprising at least one of setting a value and adjusting a value of the first threshold based on at least one of pre-failure event data and failure event data of a second system in operable communication with the first system.

8. The computer-implemented method of claim 1, wherein the first set of corresponding recovery event data results from execution of a recovery flow having a plurality of steps and wherein the first set of corresponding recovery data comprises information relating to depth of recovery completed, the depth of recovery corresponding to progress through the plurality of steps.

9. The computer-implemented method of claim 1, further comprising:
storing the first likelihood of failure metric in a database, along with one or more corresponding conditions, or events associated with the first likelihood of failure metric;
providing a simulation system configured to simulate the first system;
configuring the simulation system to simulate the one or more corresponding conditions or events associated with the first likelihood of failure metric;
exercising a predetermined recovery flow in the simulation system, wherein the predetermined recovery flow is configured to perform at least one action responsive to mitigate an issue simulated in the simulation system;
evaluating the predetermined recovery flow based on how well it mitigates the issue; and
adjusting the predetermined recovery flow, based on results of exercising it in the simulation system, to improve an ability of the predetermined recovery flow to mitigate the issue.

10. The computer-implemented method of claim 1, further comprising:
aggregating at least one of recovery event data and performance metrics from the plurality of components into a set of aggregated field data; and
tuning the first time sequence machine learning model based at least in part on the aggregated field data.

11. A system, comprising:
a processor; and
a non-volatile memory in operable communication with the processor and storing computer program code that when executed on the processor causes the processor to execute a process operable to perform operations of:
receiving, upon occurrence of a first recovery event associated with a corresponding one of a plurality of components in a first system, a first set of corresponding recovery event data;
retrieving a set of first corresponding performance metrics associated with the corresponding one of the plurality of components;
providing the first set of corresponding recovery event data and the first set of corresponding performance metrics to a first time sequence machine learning model, the first time sequence machine learning model configured to analyze the first set of corresponding recovery event data and the first set of corresponding performance metrics to generate a first likelihood of failure metric for the corresponding one of the plurality of components in the first system; and
initiating, if the first likelihood of failure metric exceeds a first threshold, automatic generation of a first control signal configured to initiate an automatic action within the first system configured to mitigate at least one impact of a possible failure of the corresponding one of the plurality of components.

12. The system of claim 11, wherein the automatic action is configured to trigger at least one of logical and physical isolation of the corresponding one of the plurality of components.

13. The system of claim 11, further comprising providing computer program code that when executed on the processor causes the processor to perform an action comprising at least one of setting a value and adjusting a value of the first threshold based on at least one of pre-failure event data and failure event data of the first system.

14. The system of claim 11 further comprising providing computer program code that when executed on the processor causes the processor to perform an action comprising at least one of setting a value and adjusting a value of the first threshold based on at least one of pre-failure event data and failure event data of a second system in operable communication with the first system.

15. The system of claim 11, further comprising providing computer program code that when executed on the processor causes the processor to perform actions of:
aggregating at least one of recovery event data and performance metrics from the plurality of components into a set of aggregated field data; and
tuning the first time sequence machine learning model based at least in part on the aggregated field data.

16. The system of claim 11, wherein the first set of corresponding recovery event data results from execution of a recovery flow having a plurality of steps and wherein the first set of corresponding recovery data comprises information relating to depth of recovery completed, the depth of recovery corresponding to progress through the plurality of steps.

17. A computer program product including a non-transitory computer readable storage medium having computer program code encoded thereon that when executed on a processor of a computer causes the computer to operate a failure prediction system, the computer program product comprising:
computer program code for receiving, upon occurrence of a first recovery event associated with a corresponding one of a plurality of components in a first system, a first set of corresponding recovery event data;
computer program code for retrieving a set of first corresponding performance metrics associated with the corresponding one of the plurality of components;
computer program code for providing the first set of corresponding recovery event data and the first set of corresponding performance metrics to a first time sequence machine learning model, the first time sequence machine learning model configured to analyze the first set of corresponding recovery event data and the first set of corresponding performance metrics to generate a first likelihood of failure metric for the corresponding one of the plurality of components in the first system; and
computer program code for initiating, if the first likelihood of failure metric exceeds a first threshold, automatic generation of a first control signal configured to initiate an automatic action within the first system configured to mitigate at least one impact of a possible failure of the corresponding one of the plurality of components.

18. The computer program product of claim 17, further comprising:
computer program code for triggering at least one of logical and physical isolation of the corresponding one of the plurality of components.

19. The computer program product of claim 17, wherein the first set of corresponding recovery event data results from execution of a recovery flow having a plurality of steps and wherein the first set of corresponding recovery data comprises information relating to depth of recovery completed, the depth of recovery corresponding to progress through the plurality of steps.

20. The computer program product of claim 17, further comprising:
computer program code for aggregating at least one of recovery event data and performance metrics from the plurality of components into a set of aggregated field data; and
computer program code for tuning the first time sequence machine learning model based at least in part on the aggregated field data.
